(19) United States
(12) Patent Application Publication
(10) Pub. No.: US 2025/0343019 A1
(43) Pub. Date: Nov. 6, 2025

(54) ULTRAVIOLET CATHODE RAY TUBE

(71) Applicant: SHANGHAI JIYOUWEI OPTOELECTRONICS TECHNOLOGY. CO., LTD., SHANGHAI (CN)

(72) Inventors: JIAN ZHAO, SHANGHAI (CN); BIN ZHOU, SHANGHAI (CN); ZHONGPING XIA, SHANGHAI (CN)

(73) Assignee: SHANGHAI JIYOUWEI OPTOELECTRONICS TECH. CO., LTD., SHANGHAI (CN)

(21) Appl. No.: 18/843,701

(22) PCT Filed: May 5, 2022
(86) PCT No.: PCT/CN2022/091035

§ 371 Date: Apr. 29, 2025

(51) Int. Cl. H01J 29/20; H01J 29/18; H01J 29/48; H01J 29/86

(52) U.S. Cl. CPC H01J 29/20; H01J 29/182; H01J 29/48; H01J 29/865

(57) ABSTRACT

The embodiments of the present application relate to an ultraviolet cathode ray tube, which comprises: a glass shell, a light-emitting structure layer and an electron gun. The glass shell comprises a tubular part, a fluorescent screen part and a sealing part. The electron gun is arranged inside the tubular part and configured to emit electron beams to the fluorescent screen part. The light-emitting structure layer is arranged on the fluorescent screen part, and the light-emitting structure layer emits ultraviolet light under the excitation of the electron beam. The materials of the fluorescent screen part, the tubular part and the sealing part are all quartz glass or sapphire crystals. The sealing part is formed by deforming an end of the tubular part.

### CROSS-REFERENCE OF RELATED APPLICATION

This application claims priority to, and is a national stage entry of, PCT international application number PCT/CN2022/091035 filed on May 5, 2022, incorporated herein by reference in its entirety, which was published as PCT International Publication No. WO 2023/212875 A1 on Nov. 9, 2023, incorporated herein by reference in its entirety.

### TECHNICAL FIELD

The present application relates to the technical field of light emitting devices, in particular to an ultraviolet cathode ray tube.

### BACKGROUND

An ultraviolet light source has wide application prospects in the fields of sterilization and disinfection, surface modification, ultraviolet communication and the like. A conventional ultraviolet light source mainly includes a mercury lamp, an ultraviolet LED and an ultraviolet excimer lamp. The mercury lamp contains mercury and is prone to causing mercury pollution during production and use processes, and a frequency of the mercury lamp is unadjustable so as to limit application of the mercury lamp in the aspect of ultraviolet communication. The ultraviolet LED is low in conversion efficiency and high in production cost. The ultraviolet excimer lamp is short in service life and high in cost.

A cathode ray tube is a component that implements light emitting and imaging by exciting fluorescent powder with an electron beam and is commonly applied in a display device. Related studies on devices for implementing ultraviolet emission by using the cathode ray tube have been actively carried out recently, however, the cathode ray tube for implementing ultraviolet emission is greatly different from a conventional cathode ray tube used for imaging in structure, performance and product requirements. Many technical problems in the ultraviolet cathode ray tube are to be solved, for example, encapsulation difficult is large, light-emitting efficiency is unfavorable, light-emitting energy is low, industrialization is difficult, and production cost is high.

### SUMMARY

In view of this, for solving at least one of the problems in the background, an embodiment of the present application provides an ultraviolet cathode ray tube.

According to various embodiments of the present application, the ultraviolet cathode ray tube, includes: a glass shell, a light-emitting structure layer and an electronic gun;
the glass shell comprises a tubular part configured to contain the electronic gun and a fluorescent screen part connected with the tubular part;
the electronic gun is arranged inside the tubular part and configured to emit electron beams to the fluorescent screen part;
the light-emitting structure layer comprises a fluorescent powder layer and a conductive layer, and the light-emitting structure layer is arranged on the fluorescent screen part, and the light-emitting structure layer emits ultraviolet light under exciting of the electron beams;
a wavelength of a main emission peak of ultraviolet light emitted by the fluorescent powder layer ranges from 190 nm to 250 nm; wherein the main emission peak refers to an emission peak with the maximum light-emitting intensity of the fluorescent powder layer under exciting of the electron beams;
the glass shell further comprises a sealing part, the sealing part is connected with an end of the tubular part away from the fluorescent screen part, and the sealing part is configured to implement sealing an end opening of the end of the tubular part away from the fluorescent screen part;
materials of the fluorescent screen part, the tubular part and the sealing part are quartz glass or sapphire crystal;
the sealing part is formed by deforming an end of the tubular part; and
the glass shell encloses an airtight internal space by the fluorescent screen part, the tubular part and the sealing part, and the internal space of the glass shell is in a vacuum state.

The ultraviolet cathode ray tube provided by the embodiment of the present application includes a glass shell, a light-emitting structure layer and an electronic gun, and ultraviolet light is emitted in a manner that the electronic gun emits an electron beam to excite the light-emitting structure layer. A fluorescent screen part, a tubular part and a sealing part in the embodiment of the present application are each made of quartz glass or sapphire crystal and can be in matched connection, the glass shell has advantages of good shock resistance and good explosion resistance, so that the requirement for air tightness of the ultraviolet cathode ray tube can be better met, and a light output efficiency of a light source may be improved remarkably. The ultraviolet cathode ray tube of the present application is high in light-emitting efficiency, high in light-emitting energy, free of pollution, low in cost and easy to massively produce.

### BRIEF DESCRIPTION OF THE DRAWINGS

In order to more clearly illustrate the embodiments of the present application or the technical solutions in the prior art, the drawings required for use in the description of the embodiments will be briefly introduced below. Obviously, the drawings described below are only some embodiments recorded in the present application. For ordinary technicians in this field, other drawings can be obtained based on these drawings without paying creative labor.

FIG. 1 is a schematic structural diagram of a cathode ray tube in an embodiment of the present application.

FIG. 2 is a schematic structural diagram of a glass shell in an embodiment of the present application.

FIG. 3 is a schematic structural diagram of a glass shell in another embodiment of the present application.

FIG. 4 is a schematic structural diagram of a glass shell in a yet another embodiment of the present application.

FIG. 5 is a schematic structural diagram of a light-emitting structure layer in an embodiment of the present application.

FIG. 6 is a diagram of a luminescent spectrum of a fluorescent powder layer under exciting of electron beams in an embodiment of the present application.

FIG. 7 is a diagram of luminescent spectra of different fluorescent powder layers under exciting of electron beams in an embodiment of the present application.

FIG. 8 is a schematic structural diagram of a single-layer fluorescent powder layer in an embodiment of the present application.

FIG. 9 is a schematic structural diagram of a multi-layer fluorescent powder layer in an embodiment of the present application.

FIG. 10 is a diagram of luminescent spectra of fluorescent powder layers of different structures under exciting of electron beams in an embodiment of the present application.

FIG. 11 is a flowchart of a method for preparing a fluorescent powder layer in an embodiment of the present application.

FIG. 12 is a surface SEM diagram of a fluorescent powder layer in an embodiment of the present application.

FIG. 13 is a flowchart of a method for preparing a light-emitting structure layer in an embodiment of the present application.

FIG. 14 is a schematic diagram of the structure of the fluorescent screen of an embodiment of the present application.

FIG. 15 is a SEM image of the surface of the first structural layer of an embodiment of the present application.

FIG. 16 is a flow chart of the method for preparing the fluorescent screen of an embodiment of the present application.

FIG. 17 is a schematic structural diagram of an electronic gun in an embodiment of the present application.

FIG. 18 is a schematic structural diagram of an electrical lead assembly in an embodiment of the present application.

### DETAILED DESCRIPTION OF PREFERRED EMBODIMENTS

In order to enable those skilled in the art to better understand the technical solutions in the present application, the technical solutions in the embodiments of the present application will be clearly and completely described below in conjunction with the accompanying drawings in the embodiments of the present application. Although exemplary embodiments of the present application are shown in the drawings, it should be understood that the present application can be implemented in various forms and should not be limited to the specific embodiments set forth herein. On the contrary, these embodiments are provided to enable a more thorough understanding of the embodiments of the present application and to fully convey the scope of the disclosure of the present application to those skilled in the art.

It will be understood that, although the terms first, second, third etc. may be used to describe various features, these features should not be limited by these terms. These terms are only used to distinguish one feature from another. Thus, a first feature discussed below could be termed a second feature without departing from the teachings of the present invention. When discussing the second feature, it does not mean that the present invention necessarily has the first feature. The singular forms “a”, “an” and “the” are intended to include the plural forms as well, unless the context clearly indicates otherwise. It should also be understood that the terms “comprising” and/or “including”, when used in this instructions, determine the presence of stated structures and/or steps, but do not exclude the presence or addition of one or more other structures and/or steps. As used herein, the term “and/or” includes any and all combinations of the associated listed items.

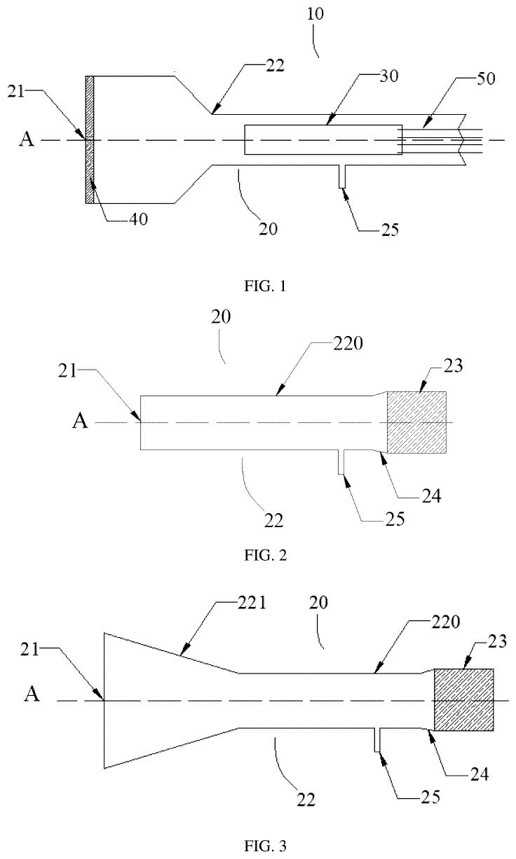

As shown in FIG. 1, an ultraviolet cathode ray tube 10 provided by an embodiment of the present application includes a glass shell 20 and an electronic gun 30. The glass shell 20 includes a fluorescent screen part 21 and a tubular part 22 connected with the fluorescent screen part 21, and the electronic gun 30 is arranged in the tubular part 22 and configured to emit an electron beam to the fluorescent screen part 21.

For clearly describing the technical solution of the present application, an axis “A” shown in FIG. 1 to FIG. 4 is defined, and the axis “A” is a central axis of the fluorescent screen part 21. An extending direction of the axis “A” is called a longitudinal direction. It may be understood that the extending direction of the axis “A” is perpendicular to a surface of the fluorescent screen part 21. The fluorescent screen part 21 is connected to an end of the tubular part 22. The fluorescent screen part 21 has an internal surface facing the tubular part 22 and an external surface away from the tubular part 22. Both the internal surface and the external surface of the fluorescent screen part 21 are perpendicular to the axis “A”.

Optionally, the fluorescent screen part 21 is made of one or more types of inorganic light-transmitting materials. The inorganic light-transmitting material has an ultraviolet light transmittance being greater than or equal to 80% in a waveband range from 190 nm to 250 nm. Optionally, the inorganic light-transmitting material may be one of quartz glass, sapphire crystal or magnesium fluoride crystal. Further, the inorganic light-transmitting material is the quartz glass or the sapphire crystal. Compared with common electronic glass, the quartz glass or the sapphire crystal has advantages of being lead-free, high in purity and the like, so as to reduce pollution, reduce absorption of impurities for ultraviolet light and improve ultraviolet light output efficiency of the cathode ray tube.

Optionally, a material of the tubular part 22 and a material of the fluorescent screen part 21 are both quartz glass or sapphire crystal. Accordingly, the tubular part 22 and the fluorescent screen part 21 are connected in matched sealing, a stress problem hardly exists in a sealing position, a sealing effect of the glass shell is good, a sealing technique may be large-scale so that cost is low, and the glass shell has advantages of good shock resistance, good explosion resistance and the like. It needs to be noted that the matched connection in the embodiment of the present application means that two types of sealing materials have the similar or same thermal expansion coefficient and may be contracted to remain consistent during a gradual cooling process after high-temperature sealing, so that internal stress caused by a contraction difference may be eliminated.

As a feasible implementation, the fluorescent screen part 21 and the tubular part 22 are formed respectively and then formed by cooling after being sealed under high-temperature melting. As the materials are the same, the fluorescent screen part 21 and the tubular part 22 are basically consistent in softening temperature and thermal expansion coefficient, so the glass shell 20 with the stable performance may be easy to seal and form. As another feasible implementation, the fluorescent screen part 21 and the tubular part 22 are formed in a one-time melting forming technique. Specifically, raw materials are molten to a plasticity state, then the molten raw materials are cooled and formed according to a requirement for a shape and a size of the glass shell 20, so as to obtain the glass shell 20 including the fluorescent screen part 21 and the tubular part 22, and thus not only may production efficiency of the glass shell 20 be improved, but also the internal stress may be further reduced due to omitting of a sealing process. The glass shell 20 has high shock resistance and stability.

Optionally, the fluorescent screen part 21 is in a disk shape, and the corresponding internal surface of the fluorescent screen part 21 has a round profile. Optionally, the tubular part 22 is in a shape of a round tube, and an internal diameter of the tubular part 22 is less than or equal to a diameter of the internal surface of the fluorescent screen part 21. Compared with a common square internal surface of the fluorescent screen part 21 or the internal surface in other shapes, the round internal surface may receive more electron beam bombardment under the same area, so as to improve the ultraviolet light emitting intensity. In addition, if the implementation that the fluorescent screen part 21 and the tubular part 22 are formed respectively and then sealed, during the sealing process of the fluorescent screen part 21 and the tubular part 22, the disk-shape fluorescent screen part 21 has a smooth side surface, sealing of all positions is easier to control consistently, and stress caused by inconsistent thickness of the sealed positions may be reduced. Optionally, the fluorescent screen part 21 has a thickness ranging from 0.5 mm to 3 mm. Optionally, a tube wall of the tubular part 22 has thickness ranging from 0.5 mm to 2 mm.

As shown in FIG. 2 to FIG. 4, the glass shell 20 includes the tubular part 22 and the fluorescent screen part 21. The tubular part 22 includes a first barrel portion 220, and an internal surface of the first barrel portion 220 is perpendicular to the internal surface of the fluorescent screen part 21. Optionally, the first barrel portion 220 may be directly connected with the fluorescent screen part 21 (as shown in FIG. 2) or may be not directly connected. In the case of being not directly connected, the tubular part 22 may further include a cone portion 221, and the first barrel portion 220 is connected with the fluorescent screen part 21 through the cone portion 221. Further, the cone portion 221 is connected with the fluorescent screen part 21 through a second barrel portion 222. Specifically, FIG. 2 to FIG. 4 show three optional implementations of the glass shell 20.

As shown in FIG. 2, as an optional implementation of the glass shell 20, the tubular part 22 includes the first barrel portion 220, and an end of the first barrel portion 220 is connected with the fluorescent screen part 21. Optionally, the internal surface of the first barrel portion 220 is perpendicular to the internal surface of the fluorescent screen part 21, namely, the first barrel portion 220 and the fluorescent screen part 21 constitute a bottom-sealed barrel. Accordingly, on the one hand, solution quantities in upper portions of all regional positions of the internal surface of a fluorescent screen may keep consistent during a fluorescent powder sedimenting process, so that the fluorescent powder are more uniformly sedimented on the internal surface of the fluorescent screen part 21, and on the other hand, a thickness of a side wall of a barrel-shaped portion is easier to control during a machining process, so that the consistent thickness is easier to achieve, and the shock resistance and the explosion resistance are better.

As shown in FIG. 3, as another optional implementation of the glass shell 20, the tubular part 22 includes the cone portion 221 and the first barrel portion 220. The cone portion 221 includes a small-opening end close to the first barrel portion 220 and a large-opening end away from the first barrel portion 220. The large-opening end of the cone portion 221 is connected with the fluorescent screen part 21, and the small-opening end of the cone portion 221 is connected with the first barrel portion 220. The electronic gun 30 is arranged in the tubular part 22. Specifically, the electronic gun 30 is arranged in the first barrel portion 220. Optionally, a ratio of a distance from an end face of the small-opening end of the cone portion 221 to the internal surface of the fluorescent screen part 21 to the diameter of the internal surface of the fluorescent screen part 21 ranges from 1:0.5 to 1:4, so that angles of the electron beams are convenient to control and then the electron beams are uniformly emitted to the internal surface of the whole fluorescent screen part 21.

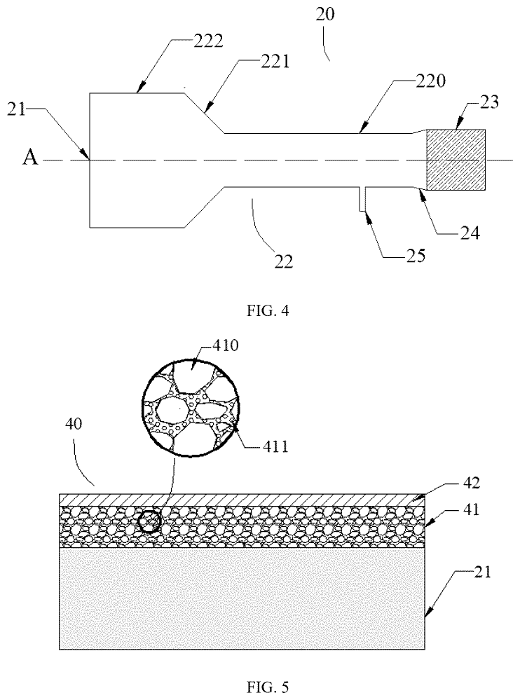

As shown in FIG. 4, as another optional implementation of the glass shell 20, the tubular part 22 includes the first barrel portion 220, the cone portion 221 and a second barrel portion 222, and an internal diameter of the second barrel portion 222 is greater than an internal diameter of the first barrel portion 220. The cone portion 221 includes the small-opening end close to the first barrel portion 220 and the large-opening end away from the first barrel portion 220. An end of the second barrel portion 222 is connected with the large-opening end of the cone portion 221, another end of the second barrel portion 222 is connected with the fluorescent screen part 21, and the small-opening end of the cone portion 221 is connected with the first barrel portion 220. It needs to be noted that the end face of the small-opening end of the cone portion 221, an end face of the large-opening end of the cone portion 221 and the internal surface of the fluorescent screen part 21 are parallel to one another. Optionally, an internal surface of the second barrel portion 222 is perpendicular to the internal surface of the fluorescent screen part 21, namely, the second barrel portion 222 and the fluorescent screen part 21 constitute a bottom-sealed barrel. The electronic gun 30 is arranged in the tubular part 22. Specifically, the electronic gun 30 is arranged in the first barrel portion 220. By making the internal surface of the second barrel portion 222 perpendicular to the internal surface of the fluorescent screen part 21, solution quantities over the internal surface of the fluorescent screen part 21 are the same in a gravity sedimenting method, the fluorescent powder may be uniformly sedimented on the internal surface of the fluorescent screen under the action of gravity, namely, the thickness of the fluorescent powder in all positions of the internal surface of the fluorescent screen may be more uniform, and thus a light-emitting effect is improved. Optionally, a height of the second barrel portion 222 is greater than or equal to 20 mm, so that the fluorescent powder may be more uniformly distributed at a bottom of the glass shell 20, and uniformity of a fluorescent powder layer is improved. It may be understood that the height of the second barrel portion 222 refers to a length of the second barrel portion 222 in an axis “A” direction. Optionally, the ratio of the distance from the end face of the small-opening end of the cone portion 221 to the internal surface of the fluorescent screen part 21 to the diameter of the internal surface of the fluorescent screen part 21 ranges from 1:0.5 to 1:4, so that the angles of the electron beams are convenient to control and then the electron beams are uniformly emitted to the internal surface of the whole fluorescent screen part 21, and otherwise, too small or too large angles of the electron beams are not good for uniformly emitting the electron beams to the internal surface of the whole fluorescent screen part 21. Optionally, a ratio of a distance from the end face of the small-opening end of the cone portion 221 to the end face of the large-opening end of the cone portion 221 to the height of the second barrel portion 222 ranges from 0.5:1 to 2:1, so that all the electron beams may be more easily controlled to be emitted to the internal surface of the fluorescent screen part 21, and the electron beams are prevented from being blocked by the internal surface of the cone portion 221.

It may be understood that in this embodiment, the cone portion 221 is not limited to a case that a side wall from the small-opening end to the large-opening end extends in a constant-slope straight line shown in FIG. 3 or FIG. 4, the cone portion 221 may also include a variable-slope side wall or even include a plurality of segments of auxiliary cone portions, and each segment of auxiliary cone portion may also be connected to another segment of auxiliary cone portion through another barrel portion, which is not described in detail here.

It may be understood that a section size of the cone portion 221 in a direction perpendicular to the axis “A” gradually increases or decreases; and a section size of the barrel portion in the direction perpendicular to the axis “A” does not change.

Optionally, as shown in FIG. 2 to FIG. 4, the glass shell 20 further includes a sealing part 23, and the sealing part 23 is connected with an end of the tubular part 22 away from the fluorescent screen part 21. The sealing part 23 is configured to implement sealing an end opening of the end of the tubular part 22 away from the fluorescent screen part 21. The glass shell 20 encloses an airtight internal space by the fluorescent screen part 21, the tubular part 22 and the sealing part 23, and the internal space of the glass shell 20 is in a vacuum state. Specifically, an air pressure of the internal space of the glass shell 20 may range from 10-2 Pa to 10-7 Pa, so as to reduce influence of residual air in the internal space on the electron beams and a cathode. Optionally, a thickness of the sealing part 23 is greater than a thickness of a tube wall of the tubular part 22 and less than the internal diameter of the tubular part 22. Optionally, a material of the sealing part 23 is quartz glass or sapphire crystal. A mercury lamp and an excimer ultraviolet lamp in existing ultraviolet light sources belong to a gas discharge lamp, an air pressure inside the gas discharge lamp is 5 to 10 times the atmospheric pressure of the outside, and in the embodiment of the present application, the atmospheric pressure of the outside is 10⁷ to 10¹² times the air pressure inside the glass shell. Thus, compared with the gas discharge lamp, the requirement for the sealing and air-tightness of the glass shell in the embodiment of the present application are much higher, and the material of the fluorescent screen part, the material of the sealing part and the material of the tubular part are all quartz glass or sapphire crystal, so that the matched sealing may be better formed, and the requirement for the air-tightness of the glass shell is met. Optionally, the sealing part 23 may be, for example, formed by deforming an end of the tubular part 22, specifically, an opening end of the tubular part 22 may be pressed in a high-temperature heating and melting state and then cooled to be formed. A largest section of the formed sealing part is parallel to the axis “A”. During specific application, the sealing part 23 is in a flat shape, a length of the flat-shaped sealing part is greater than 15 mm, and the length of the sealing part is a length in the axis “A” direction. It may be understood that the flat-shaped sealing part 23 specifically means that a length and a width of the sealing part 23 are apparently greater than a thickness of the sealing part 23, for example, the sealing part 23 has the length being greater than 15 mm, the width being greater than 10 mm and the thickness being less than 4 mm. It needs to be noted that during a process of deforming the end of the tubular part 22 to form the sealing part 23, a transition part 24 may also be formed between the tubular part 22 and the sealing part 23; an end of the transition part 24 is connected with the tubular part 22, and the other end of the transition part 24 is connected with the sealing part 23; and the transition part 24 specifically refers to a portion where a tube opening is gradually closed but not completely closed after the end of the tubular part 22 is pressed and deformed. Compared with a traditional sealing manner, the sealing part 23 provided by the embodiment of the present application has a better sealing effect, on the one hand, both the material of the sealing part and the material of the tubular part are quartz glass or sapphire crystal, so as to form matched sealing, the sealing effect is good, and the requirement for the air-tightness of the glass shell is met; and on the other hand, the sealing part directly formed by deforming the opening end of the tubular part may form a smooth connection during a process of high-temperature heating and sealing, sealing is convenient and simple, and meanwhile, the better connection effect is achieved.

Optionally, as shown in FIG. 2 to FIG. 4, the glass shell 20 further includes an air exhaust part 25. Specifically, the air exhaust part 25 is arranged on the tubular part 22, an end of the air exhaust part 25 is connected with an interior of a tube, and the other end of the air exhaust part 25 is sealed. Optionally, a material of the air exhaust part 25 is the same as the material of the tubular part 22. During specific application, the side wall of the tubular part 22 is locally heated in a high temperature to be a molten state, then an end of an air exhaust tube with two ends being open is inserted into the side wall which is heated in the high temperature to be the molten state, and after cooling, the air exhaust tube is fixed to the tubular part 22. When an air exhausting opening is needed, an opening of the other end of the air exhaust tube is connected with an air extractor to perform an air extracting operation, and when a vacuum degree inside the tube reaches a preset value, the other end of the air exhaust tube is heated to be a molten state, then pressed and sealed and then cooled to form the air exhaust part 25. Optionally, the air exhaust part 25 is arranged on the tubular part 22 on a side close to the electronic gun 30, namely, a distance between the air exhaust part 25 and the electronic gun 30 is less than a distance between the air exhaust part 25 and a fluorescent part. Specifically, in the embodiment where the tubular part 22 includes the cone portion 221, the air exhaust part 25 is arranged on the first barrel portion 220, an internal surface and an external surface of the first barrel portion 220 have no other coating, and thus the air exhaust part is more convenient to arrange.

Optionally, the cathode ray tube 10 further includes an anode metal bar (not shown in the figure). The anode metal bar penetrates through the tubular part 22, specifically, an end of the anode metal bar is arranged inside the tubular part 22 and connected with a conductive layer of an inner wall of the tubular part 22, and the other end of the anode metal bar is arranged on the tubular part 22 and connected with a high voltage of the outside, so that a high voltage electric field is formed on the inner wall of the tubular part 22. Optionally, a middle position of the anode metal bar is in fused connection with the tubular part 22. Specifically, a surface of the anode metal bar is coated with a layer of transition metal film, a thermal expansion coefficient of the transition metal film is in a range between the thermal expansion coefficient of the glass shell 20 and a thermal expansion coefficient of the anode metal bar. The anode metal bar is a tungsten bar, and the transition metal film may be a nickel film. A problem of the internal stress caused by the unmatched thermal expansion coefficient is reduced through the transition metal film, so the sealing effect is improved. Optionally, the anode metal bar is arranged on the tubular part 22 on a side close to the fluorescent screen part 21.

As shown in FIG. 1, the ultraviolet cathode ray tube 10 in the embodiment of the present application further includes a light-emitting structure layer 40. The light-emitting structure layer 40 is arranged on the fluorescent screen part 21 and emits ultraviolet light under exciting of the electron beams.

FIG. 5 shows a schematic structural diagram of a light-emitting structure layer in an embodiment of the present application. The light-emitting structure layer 40 includes a fluorescent powder layer 41. The fluorescent powder layer 41 is arranged on the fluorescent screen part 21. The electronic gun 30 is configured to emit the electron beams to the fluorescent screen part 21 and specifically configured to emit all or most of electron beams to the fluorescent powder layer 41. The fluorescent powder layer 41 emits ultraviolet light under exciting of the electron beams.

During specific application, the fluorescent powder layer 41 is arranged on the internal surface of the fluorescent screen part 21. Here, the internal surface refers to a surface of a side of the fluorescent screen part 21 close to the electronic gun 30. Optionally, the fluorescent powder layer 41 has a thickness ranging from 5 μm to 50 μm. Here, the thickness of the fluorescent powder layer 41 is a distance between the internal surface of the fluorescent screen part 21 and a surface of the fluorescent powder layer 41. The surface of the fluorescent powder layer 41 refers to a surface of a side of the fluorescent powder layer 41 facing the electronic gun 30.

Optionally, a wavelength of a main emission peak of ultraviolet light emitted by the fluorescent powder layer 41 under exciting of the electron beams ranges from 190 nm to 250 nm. It needs to be noted that the main emission peak in the embodiment of the present application refers to the maximum emission peak of a light-emitting intensity under exciting of the electron beams. It is easy to understand that if the emitted ultraviolet light further includes another emission peak, a light-emitting intensity of any other emission peak is less than a light-emitting intensity of the main emission peak. It needs to be noted that wavelengths of different emission peaks have an interval of at least 5 nm. If the wavelengths of the different emission peaks have an interval within 5 nm, the different emission peaks are regarded as the same emission peak. In the ultraviolet light, the shorter the wavelength is, the stronger the energy is and the weaker the penetrating power is, for example, in the field of sterilization and disinfection, the shorter the wavelength is, the higher the energy of the ultraviolet light is, DNA of viruses or bacterial cells can be more effectively destroyed, in addition, the penetrating power is weak, so that harm to the skin of a human body may be reduced, and thus the shorter the wavelength is, the greater the application prospects of the ultraviolet light is. The ultraviolet cathode ray tube 10 in the embodiment of the present application emits ultraviolet light in the manner of exciting the fluorescent powder layer 41 by the electron beams, and the wavelength of the main emission peak of the emitted ultraviolet light ranges from 190 nm to 250 nm. Compared with 254 nm mercury lamp and ultraviolet LED lamp, the wavelength of the ultraviolet light emitted by the embodiment of the present application is shorter, the light-emitting energy is high, meanwhile, the light-emitting intensity is adjustable, a light-emitting frequency is adjustable, and it has wider application prospects in the fields such as sterilization and disinfection, ultraviolet communication and ultraviolet curing.

Optionally, the emitted ultraviolet light within the wavelength in a range less than or equal to 300 nm further includes at least one auxiliary emission peak, and a ratio of a light-emitting intensity of the auxiliary emission peak to the light-emitting intensity of the main emission peak is greater than or equal to 1:10. Specifically, for example, the ultraviolet light emitted by the fluorescent powder layer containing LaPO₄:Pr fluorescent powder under exciting of the electron beams includes the main emission peak and one auxiliary emission peak, where the wavelength of the main emission peak is 225 nm, and the wavelength of the auxiliary emission peak is 280 nm.

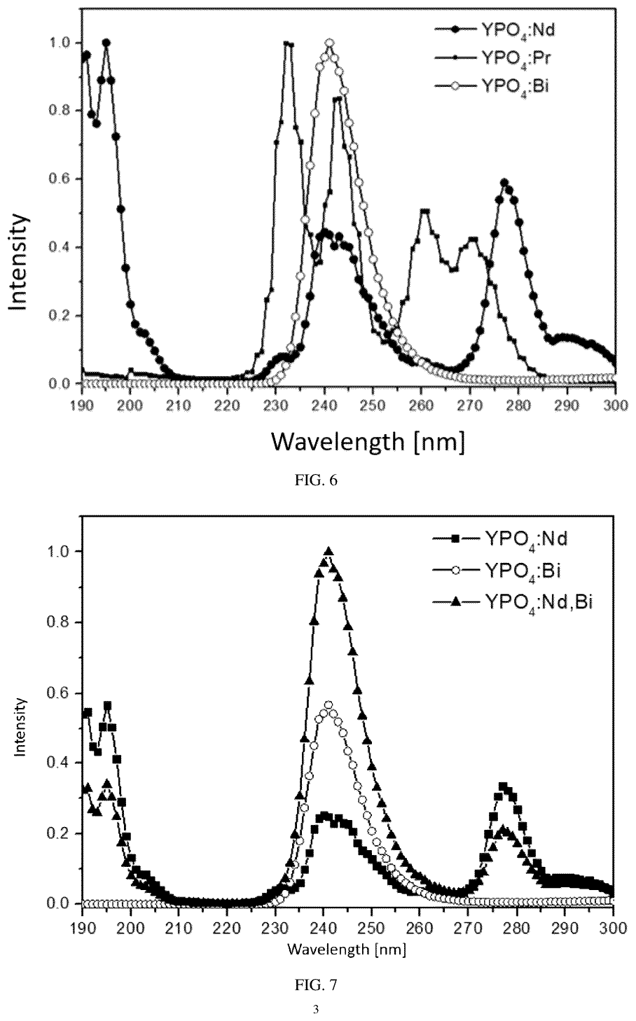

Optionally, the emitted ultraviolet light within the wavelength in a range less than or equal to 300 nm further includes two or more auxiliary emission peaks, and a ratio of a light-emitting intensity of the auxiliary emission peak to the light-emitting intensity of the main emission peak is greater than or equal to 1:10. Specifically, FIG. 6 shows a diagram of a luminescent spectrum of a fluorescent powder layer under exciting of electron beams in an embodiment of the present application, and the ultraviolet light emitted by the fluorescent powder layer containing YPO₄:Pr fluorescent powder in the figure includes the main emission peak and three auxiliary emission peaks, where the wavelength of the main emission peak is 232 nm, a wavelength of the first auxiliary emission peak is 243 nm, a wavelength of the second auxiliary emission peak is 261 nm, and a wavelength of the third auxiliary emission peak is 271 nm.

Optionally, an integrated emitting intensity of the ultraviolet light emitted by the fluorescent powder layer 41 under exciting of the electron beams while the wavelength is in a range from 190 nm to 250 nm is greater than an integrated emitting intensity while the wavelength is in a range from 250 nm to 300 nm. The integrated emitting intensity refers to a sum of integrated intensities in a certain wavelength range, which is represented by a formula that G=∫f(x)dx, where G represents the integrated emitting intensity, x represents the wavelength, and f(x) represents the emitting intensity while the wavelength is x.

As shown in FIG. 5, the fluorescent powder layer 41 in the embodiment of the present application may include fluorescent powder 410, and emitting ultraviolet light by the fluorescent powder layer 41 under exciting of the electron beams is specifically that the fluorescent powder 410 emits ultraviolet light under exciting of the electron beams.

Optionally, the fluorescent powder includes a base material and a doping element. The doping element is doped into the base material to form an impurity defect so as to cause light-emitting. Optionally, the doping element contains Nd, Pr or Bi, and the element Nd, Pr or Bi may emit ultraviolet light less than 250 nm after absorbing the energy of the electron beams and also has the advantages of high light-emitting efficiency, short light-emitting wavelength and the like. Optionally, the base material is a rare earth phosphate, and the rare earth phosphate has the advantages of low phonon energy, stable property and the like, is capable of resisting electron beam bombardment as the base material and may remarkably improve the light-emitting intensity and prolong the service life of the fluorescent powder layer.

As an optional implementation, the fluorescent powder contains the doping element, the doping element contains at least one type selected from Nd, Pr and Bi, and the doping element emits ultraviolet light under exciting of the electron beams. Optionally, as the doping element, Nd, Pr and Bi mainly have stable trivalent electron configuration. Further, the fluorescent powder may include at least one of the following: RePO₄:Z₁, LaP₅O₁₄:Z₁, CaSO₄:Z₁, SrSO₄:Z₁, NaYF₄:Z₁, LiYF₄:Z₁, KYF₄:Z₁, LiLaP₄O₁₂:Z₁, Y₂(SO₄)₃:Z₁, YAlO₃:Z₁ and YF₃:Z₁, where Re represents one or more types selected from Y, La, Lu, Sr, Gd, Sm and Ce, Z₁ represents the doping element, and the doping element contains a type of element selected from Nd, Pr and Bi. Optionally, a molar ratio of the doping element to a doped element in the base material is less than 5:95, namely, a concentration of the doping element is less than or equal to 5%. As shown in FIG. 6, the wavelength of the main emission peak of the ultraviolet light emitted by the fluorescent powder layer containing YPO₄:Nd fluorescent powder (a doping concentration of Nd is 1%, namely, a molar ratio of Y to Nd is 99:1) is 195 nm, the wavelength of the first auxiliary emission peak is 277 nm, and the wavelength of the second auxiliary emission peak is 240 nm. In a luminescent spectrum curve in the figure, an intensity integral area while the wavelength is in a range from 190 nm to 250 nm is 14.3. In the luminescent spectrum curve, an intensity integral area while the wavelength is in a range from 250 nm to 300 nm is 8.9, and an integrated emission intensity of the emitted ultraviolet light while the wavelength is in a range from 190 nm to 250 nm is greater than an integrated emission intensity while the wavelength is in a range from 250 nm to 300 nm. Table 1 shows a wavelength of the main emission peak in an emitted spectrum by a cathode ray of fluorescent powder in the embodiment of the present application. In the table, a concentration of the doping element in the fluorescent powder is 1%, and an accelerating voltage of the electron beams is 10 kV. It needs to be understood that the wavelength of the main emission peak in the light-emitting spectrum by the cathode ray of the fluorescent powder is affected by a particle diameter of the fluorescent powder, a doping concentration and the accelerating voltage of the electron beams, so wavelengths of the main emission peak under different conditions may be different. Meanwhile, the fluorescent powder in the embodiment of the present application is fluorescent powder that emits light under exciting of the electron beams, which is totally different from photoluminescent fluorescent powder. Though the same fluorescent powder is adopted, spectrum curves under exciting of the electron beams and exciting of illuminating are not totally the same.

TABLE 1

| | Fluorescent | Wavelength (nm) of a |
|---|---|---|
| Number | powder | main emission peak |
| 1 | LiYF₄:Pr | 218 |
| 2 | KYF₄:Pr | 235 |
| 3 | YPO₄:Pr | 232 |
| 4 | LaPO₄:Pr | 225 |
| 5 | YAlO₃:Pr | 245 |
| 6 | YPO₄:Bi | 241 |
| 7 | YPO₄:Nd | 195 |
| 8 | LuPO₄:Pr | 235 |
| 9 | LaPO₄:Bi | 234 |
| 10 | LaPO₄:Nd | 192 |

As another optional implementation, the fluorescent powder contains the doping element, and at least two types of doping elements selected from Nd, Pr and Bi emit ultraviolet light after being excited by the electron beams. In the doping elements, Nd, Pr and Bi mainly have stable trivalent electron configuration, and under exciting of the electron beams, energy transfer may be formed among Nd, Pr and Bi so as to improve the light-emitting intensity of the ultraviolet light. Further, the fluorescent powder may include at least one of the following: RePO₄:Z₂, LaP₅O₁₄:Z₂, CaSO₄:Z₂, SrSO₄:Z₂, NaYF₄:Z₂, LiYF₄:Z₂, KYF₄:Z₂, LiLaP₄O₁₂:Z₂, Y₂(SO₄)₃:Z₂, YAlO₃:Z₂ and YF₃:Z₂, where Re represents one or more types selected from Y, La, Lu, Sr, Gd, Sm and Ce, Z₂ represents the doping element, and the doping elements contain two types of elements selected from Nd, Pr and Bi. Optionally, a molar ratio of the doping element to a doped element is less than 5:95. FIG. 7 shows a diagram of luminescent spectra of fluorescent powder layers containing YPO₄:Nd (a doping concentration of Nd is 1%) fluorescent powder, YPO₄:Bi (a doping concentration of Bi is 1%) fluorescent powder and YPO₄:Nd,Bi (a doping concentration of Nd is 1% and a doping concentration of Bi is 1%) fluorescent powder respectively under exciting of the electron beams in a case that the fluorescent powder layer has the same thickness, where a wavelength of a main emission peak of the fluorescent powder layer containing the YPO₄:Nd fluorescent powder is 195 nm, a wavelength of a first auxiliary emission peak is 277 nm, and a wavelength of a second auxiliary emission peak is 240 nm; and a wavelength of a main emission peak of the fluorescent powder layer containing the YPO₄:Bi fluorescent powder is 241 nm; and a wavelength of a main emission peak of the fluorescent powder layer containing the YPO₄:Nd,Bi fluorescent powder is 241 nm, a wavelength of a first emission peak is 195 nm, and a wavelength of a second auxiliary emission peak is 277 nm. It may be seen from the figure that a light-emitting intensity of the fluorescent powder layer containing the YPO₄:Nd, Bi fluorescent powder at 195 nm and 277 nm is less than a light-emitting intensity of YPO₄:Nd, and a light-emitting intensity at 241 nm is greater than a light-emitting intensity of YPO₄:Bi; and this is because in the fluorescent powder layer containing the YPO₄:Nd,Bi fluorescent powder, energy transfer is formed between the doping element Nd and the doping element Bi, namely, a part of electron energy absorbed by Nd is transferred to Bi, so not only may the light-emitting intensity of the element Bi at 241 nm be improved, but also the whole ultraviolet light emitting intensity of the fluorescent powder layer in a range less than 300 nm may be improved. It may be apparently seen from the figure that integrated emitting intensities of the ultraviolet light emitted by the three types of fluorescent powder layers while the wavelength is in a range from 190 nm to 250 nm are each greater than an integrated emitting intensity while the wavelength is in a range from 250 nm to 300 nm.

The fluorescent powder layer in the embodiment of the present application may be a single-layer fluorescent powder layer or a multi-layer fluorescent powder layer.

As an optional implementation, the fluorescent powder layer is the single-layer fluorescent powder layer.

Optionally, the single-layer fluorescent powder layer may include one type of fluorescent powder or two or more types of fluorescent powder. The single-layer fluorescent powder layer includes two or more types of fluorescent powder, so that ultraviolet light with various different wavelengths may be obtained through ultraviolet light emitted by the different fluorescent powder, thus demands in the different fields are met, for example, in the field of sterilization and disinfection, the ultraviolet light with the various different wavelengths can effectively kill various bacteria or viruses, so that the sterilization or disinfection effect is improved. Further, the two types of fluorescent powder included in the single-layer fluorescent powder layer may be YPO₄:Nd and YPO₄:Pr, or YPO₄:Nd and LaPO₄:Pr, or YPO₄:Pr and LaPO₄:Pr. The ultraviolet light emitted by the YPO₄:Nd fluorescent powder, the YPO₄:Pr fluorescent powder and the LaPO₄:Pr under exciting of the electron beams has a plurality of emission peaks, and the single-layer fluorescent powder layer includes two of them so that ultraviolet light with more wavelengths may be emitted at the same time, and the demands, for example, in the field of sterilization and disinfection are met.

In a specific application, the single-layer fluorescent powder layer may include two or more types of fluorescent powder that are mixed. Specifically, the two or more types of fluorescent powder are directly mixed and then the single-layer fluorescent powder layer is formed through a gravity sedimenting method.

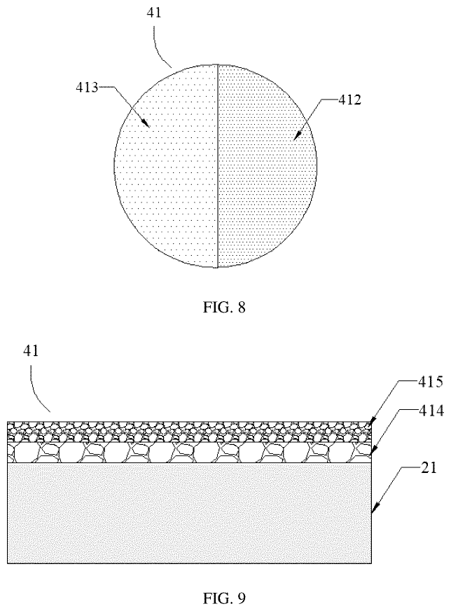

In another specific application, the single-layer fluorescent powder layer may include two or more subregion fluorescent powder layers. Optionally, wavelengths of main emission peaks of ultraviolet light emitted by the subregion fluorescent powder layers under exciting of the electron beams are different, and the wavelength of the main emission peak of the ultraviolet light emitted by at least one subregion fluorescent powder layer ranges from 190 nm to 250 nm. Optionally, the subregion fluorescent powder layers contain different types of fluorescent powder, and the types of fluorescent powder being different means that the subregion fluorescent powder layers at least include one different type of fluorescent powder. It may be understood that though the single-layer fluorescent powder layer includes two or more subregion fluorescent powder layers, the subregion fluorescent powder layers are located on the same layer, lower surfaces of the subregion fluorescent powder layers are coplanar approximately, upper surfaces of the subregion fluorescent powder layers are also coplanar approximately, and the subregion fluorescent powder layers jointly constitute a layer of fluorescent powder layer. Specifically, FIG. 8 shows a schematic structural diagram of a single-layer fluorescent powder layer in an embodiment of the present application, wherein the fluorescent powder layer 41 at least includes a first subregion fluorescent powder layer 412 and a second subregion fluorescent powder layer 413, and the first subregion fluorescent powder layer 412 and the second subregion fluorescent powder layer 413 are arranged on different regions of the internal surface of the fluorescent screen part 21. The first subregion fluorescent powder layer 412 emits first ultraviolet light under exciting of the electron beams, the second subregion fluorescent powder layer 413 emits second ultraviolet light under exciting of the electron beams, a wavelength of a main emission peak of the first ultraviolet light is different from a wavelength of a main emission peak of the second ultraviolet light, and at least one of the wavelength of the main emission peak of the first ultraviolet light and the wavelength of the main emission peak of the second ultraviolet light ranges from 190 nm to 250 nm. Further, the type of fluorescent powder of the first subregion fluorescent powder layer 412 is different from the type of fluorescent powder of the second subregion fluorescent powder layer 413. It may be understood that the types of the fluorescent powder being different means that the subregion fluorescent powder layer at least include one different type of fluorescent powder, for example, the first subregion fluorescent powder layer includes the fluorescent powder LuPO₄:Bi, and the second subregion fluorescent powder layer includes the fluorescent powder LuPO₄:Pr; or the first subregion fluorescent powder layer includes the fluorescent powder LuPO₄:Bi and the fluorescent powder LuPO₄:Pr, and the second subregion fluorescent powder layer includes the fluorescent powder LuPO₄:Bi and the fluorescent powder LuPO₄:Nd; or the first subregion fluorescent powder layer includes the fluorescent powder LuPO₄:Bi, and the second subregion fluorescent powder layer includes the fluorescent powder LuPO₄:Bi and the fluorescent powder LuPO₄:Nd. Further, each subregion fluorescent powder layer may include one type of fluorescent powder or two or more types of fluorescent powder that are mixed. By arranging the fluorescent powder layers on the different regions in the embodiment of the present application, ultraviolet light with various different wavelengths may be generated, the ultraviolet light with the various wavelengths may be overlaid together, influence of mutual absorption between the different fluorescent powder is reduced, and thus the whole light-emitting intensity of the ultraviolet cathode ray tube is improved.

As another optional implementation, the fluorescent powder layer includes two or more layers of overlaid fluorescent powder layers. Each layer of fluorescent powder layer may include one type of fluorescent powder or two or more types of fluorescent powder that are mixed. The types of fluorescent powder included in all the fluorescent powder layers are different. It may be understood that the types of fluorescent powder being different means that the fluorescent powder layers at least include one different type of fluorescent powder. Wavelengths of the main emission peaks of the ultraviolet light emitted by all the fluorescent powder layers under exciting of electron beams are different, and the wavelength of each main emission peak is 300 nm or below. Further, at least one of the wavelengths of the main emission peaks ranges from 190 nm to 250 nm. Specifically, FIG. 9 shows a schematic diagram of a multi-layer fluorescent powder layer in an embodiment of the present application. The fluorescent powder layer 41 includes a first fluorescent powder layer 414 and a second fluorescent powder layer 415, wherein the first fluorescent powder layer 414 is arranged on the internal surface of the fluorescent screen part 21, and the second fluorescent powder layer 415 is arranged on the first fluorescent powder layer 414. Further, a wavelength of a main emission peak of the first fluorescent powder layer 414 is greater than a wavelength of a main emission peak of the second fluorescent powder layer 415, so that the first fluorescent powder layer 414 may partially absorb ultraviolet light emitted by the second fluorescent powder layer 415, and a light-emitting intensity of the first fluorescent powder layer 414 is improved. By arranging the two or more layers of fluorescent powder layers, the influence of mutual absorption for ultraviolet light emitted by all the fluorescent powder layers may be effectively adjusted, so that not only may ultraviolet light with the various different wavelengths be obtained, but also an intensity of each light-emitting wavelength may be adjusted.

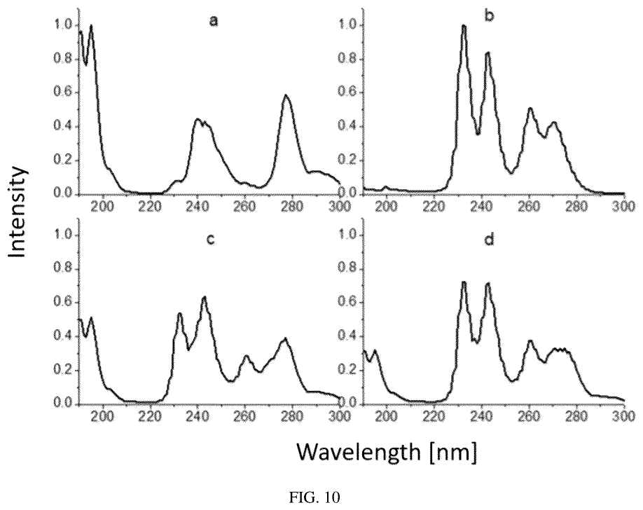

FIG. 10 shows luminescent spectra of fluorescent powder layers of different structures under exciting of electron beams in an embodiment of the present application. A curve a in the figure is a spectrum of a single-layer fluorescent powder layer containing YPO₄:Nd fluorescent powder; a curve b in the figure is a spectrum of a single-layer fluorescent powder layer containing YPO₄:Pr fluorescent powder; a curve c in the figure is a spectrum of a fluorescent powder layer containing two subregions, wherein the first subregion fluorescent powder layer contains YPO₄:Nd fluorescent powder (a quantity of YPO₄:Nd fluorescent powder is a half of a quantity of YPO₄:Nd fluorescent powder in the curve a), and the second subregion fluorescent powder layer contains YPO₄:Pr fluorescent powder (a quantity of YPO₄:Pr fluorescent powder is a half of a quantity of YPO₄:Pr fluorescent powder in the curve b); a curve d in the figure is a spectrum of a two-layer fluorescent layer, wherein a first fluorescent powder layer contains YPO₄:Pr fluorescent powder (a quantity of YPO₄:Pr fluorescent powder is the same as a quantity of YPO₄:Pr fluorescent powder in the curve c), and a second fluorescent powder layer contains YPO₄:Nd fluorescent powder (a quantity of YPO₄:Nd fluorescent powder is the same as a quantity of YPO₄:Nd fluorescent powder in the curve c); and thicknesses of the fluorescent powder layers in the curve a to the curve d are the same. The fluorescent powder layers in the curve c and the curve d each contain two types of fluorescent powder, and the curve c and the curve d each have five emission peaks, so that ultraviolet light with the various wavelengths may be generated, and it has wide application prospects in the field of sterilization and disinfection. In the curve c, the wavelength of the main emission peak is at 241 nm, and the spectrum curve is generated by simply overlaying two subregion fluorescent powder layers. In the curve d, the wavelength of the main emission peak is at 232 nm (same as the wavelength of the main emission peak in the curve b), this is because YPO₄:Pr fluorescent powder in the first fluorescent powder layer may absorb a part of light (light with a wavelength being 195 nm) emitted by YPO₄:Nd in the second fluorescent powder layer, so that an intensity of an emission peak at 232 nm in the curve d is stronger, and an intensity of an emission peak at 195 nm is weaker.

Optionally, an average particle diameter of particles of the fluorescent powder 410 ranges from 1 μm to 10 μm; when the average particle diameter of the particles is less than 1 μm, it is too small, and too many surface defects exist, which may affect light emitting; and when the average particle diameter is greater than 10 μm, the fluorescent powder is difficult to bond and prone to falling off, and making the average particle diameter of the fluorescent powder in a range from 1 μm to 10 μm, the light-emitting efficiency can be maintained, and better bonding can be achieved and falling off is prevented. Optionally, a maximum diameter of a section of a pore inside the fluorescent powder layer in a direction parallel to the internal surface of the fluorescent screen part 21 ranges from 1 μm to 10 μm.

As shown in FIG. 5, the fluorescent powder layer 41 in the embodiment of the present application may further include a bonding oxide 411. Further, the fluorescent powder layer 41 may include the bonding oxide 411 made of an inorganic material, the bonding oxide 411 is composed of inorganic particles, the inorganic material has less absorption for ultraviolet light, and especially, absorption of the bonding oxide 411 for ultraviolet light with a wavelength less than 250 nm may be reduced. Optionally, a ratio of an average particle diameter of the bonding oxide 411 to the average particle diameter of the fluorescent powder 410 ranges from 1:1000 to 1:100. Particles of the bonding oxide 411 are distributed around the particles of the fluorescent powder 410 and configured to bond the particle of the fluorescent powder 410 and bond the particles of the fluorescent powder 410 and the internal surface of the fluorescent screen part 21.

Optionally, the particles of the bonding oxide 411 are nano-particles with the average particle diameter ranging from 1 nm to 100 nm. Specifically, in the fluorescent powder layer 41, particles of at least a part of the bonding oxide 411 adhere to surfaces of the particles of the fluorescent powder 410. The bonding oxide 411 in the embodiment of the present application is nano-particles, a particle diameter of the bonding oxide 411 is far less than a particle diameter of the fluorescent powder 410, the nano-particles of the bonding oxide 411 may adhere to the surfaces of the particles of the fluorescent powder 410 and the surface of the fluorescent screen part 21 under an action of an nanometer effect, in addition, the surfaces of the nano-particles have many active hydroxyls, the nano-particles are aggregated through the active hydroxyls so as to be easy to bond together, and thus the particles of the fluorescent powder 410 as well as the particles of the fluorescent powder 410 and the surface of the fluorescent screen part 21 are bonded together.

Optionally, a mass ratio of the bonding oxide 411 to the fluorescent powder 410 is less than 1:10, so that a problem of reducing a bonding property caused by mutual aggregating of too many bonding oxides may be reduced.

Optionally, a weight percent of a main component in the bonding oxide 411 is greater than 99.9%, and a weight percent of other impurity components is less than 0.1%. The main component of the bonding oxide refers to a component that accounts for the highest proportion of the bonding oxide 411 and plays a role in bonding in the bonding oxide 411. Specifically, the main component refers to an oxide in the bonding oxide 411, in particular to a type of oxide. The other impurity components refer to impurity components generated during a preparation process of the main component of the bonding oxide. The bonding oxide 411 contains only an inorganic component and does not contain an organic component and an organic residue component. It needs to be noted that the organic component in the embodiment of the present application refers to a compound containing a C—H bond connection. The shorter the wavelength of the emitted ultraviolet light is, the higher the energy is, and the impurity component or the organic component has a stronger adsorption effect on ultraviolet light with the short wavelength. In the embodiment of the present application, the wavelength of the main emission peak of ultraviolet light emitted by the fluorescent powder layer under exciting of the electron beams ranges from 190 nm to 250 nm, and purity of the main component of the bonding oxide composed of the inorganic particles is high, so that absorption of the impurity component or the organic component for ultraviolet light may be effectively reduced, and the light-emitting efficiency is improved remarkably.

Optionally, the main component of the bonding oxide is SiO₂ or Al₂O₃. SiO₂ or Al₂O₃ is resistant to electron beam bombardment, is stable in property and has less absorption for ultraviolet light, so that the emitting intensity of the ultraviolet light may be improved.

As an optional implementation, the main component of the bonding oxide is the same as the main component of the internal surface of the fluorescent screen part 21, chemical bonding may be formed between the bonding oxide 411 and the internal surface of the fluorescent screen part through an oxygen bridge (—O—), namely, the bonding oxide 411 and the internal surface of the fluorescent screen may be connected through an oxygen atom to form chemical bonding, and thus adhesion of the fluorescent powder 410 and the internal surface of the fluorescent screen is improved. The main component of the internal surface of the fluorescent screen part 21 refers to a component that accounts for the highest proportion of components of the internal surface of the fluorescent screen part 21. In a specific application, the fluorescent screen part 21 is quartz glass, the main component of the internal surface is SiO₂, and the main component of the bonding oxide is SiO₂. In another specific application, the fluorescent screen part 21 is sapphire crystal, the main component of the internal surface is Al₂O₃, and the main component of the bonding oxide is Al₂O₃.

As another optional implementation, a buffer layer (not shown in the figure) is further arranged between the fluorescent screen part 21 and the fluorescent powder layer 41, and a main component of the buffer layer is the same as a main component of the bonding oxide. The main component of the buffer layer is a component that accounts for the highest proportion of the buffer layer. Specifically, the buffer layer is arranged on the internal surface of the fluorescent screen part 21, and the fluorescent powder layer 41 is arranged on the buffer layer. Specifically, for example, the buffer layer is in a thin film shape and may be tightly formed on the internal surface of the fluorescent screen part 21 in a manner of physical deposition (such as physical vapor deposition) or chemical deposition (such as chemical vapor deposition), and then the fluorescent powder layer 41 is formed on the buffer layer. The main component of the buffer layer and the main component of the bonding oxide 411 in the fluorescent powder layer 41 are the same and may form chemical bonding therebetween through an oxygen bridge, namely, the bonding oxide 411 in the fluorescent powder layer 41 and the buffer layer are mutually connected through an oxygen atom so as to form chemical bonding, and thus adhesion of the fluorescent powder 410 and the internal surface of the fluorescent screen is improved.

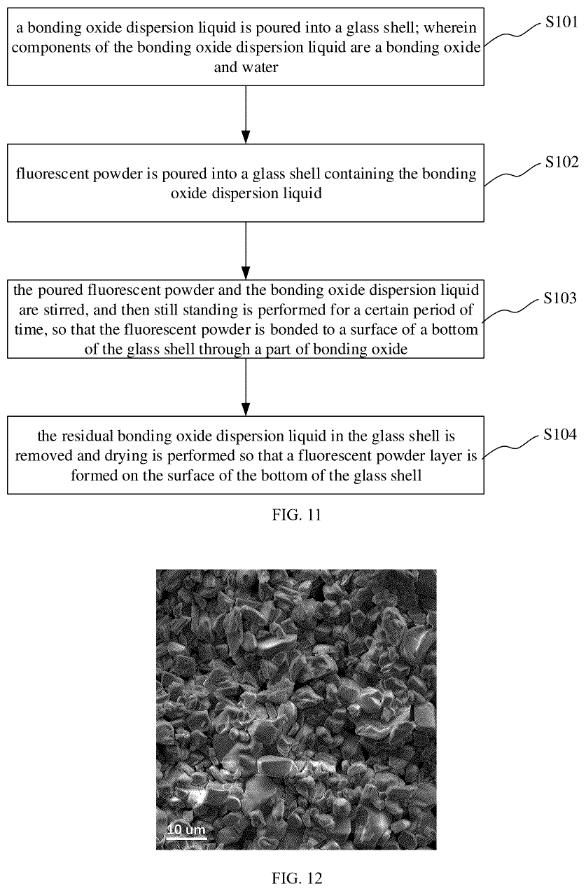

As shown in FIG. 11, an embodiment of the present application further provides a method for preparing a fluorescent powder layer, specifically including the following steps.
S101: a bonding oxide dispersion liquid is poured into a glass shell; wherein components of the bonding oxide dispersion liquid are a bonding oxide and water. A PH value of the bonding oxide dispersion liquid ranges from 6 to 8, and a concentration of the bonding oxide in the bonding oxide dispersion liquid is less than or equal to 5%, so that mutual aggregating of the bonding oxide due to too high concentration of the bonding oxide may be prevented. Here, the bonding oxide is an inorganic material and composed of inorganic particles. Specifically, particles of the bonding oxide are nano-particles with an average particle diameter ranging from 1 nm to 100 nm. Optionally, a weight percent of a main component of the bonding oxide is greater than 99.9%, a weight percent of other impurity components is less than 0.1%, and the main component of the bonding oxide accounts for a high proportion (namely, purity of the bonding oxide is high), so that absorption of the other impurity components for ultraviolet light may be effectively reduced, and the light-emitting efficiency is improved. The main component of the bonding oxide refers to a component that accounts for the highest proportion of the bonding oxide and plays a role in bonding in the bonding oxide. Specifically, the main component refers to an oxide in the bonding oxide, in particular to a type of oxide. The other impurity components refer to impurity components generated during a preparation process of the main component of the bonding oxide. The bonding oxide contains only an inorganic component and does not contain an organic component and an organic residue component. It needs to be noted that the organic component in the embodiment of the present application refers to a compound containing a C—H bond connection. The components of the bonding oxide dispersion liquid in the present application are the bonding oxide and the water, so that the purity of the main component of the bonding oxide in the finally formed fluorescent powder layer may be higher, absorption of the impurity component in the bonding oxide for ultraviolet light is reduced, and the light-emitting intensity is improved. As an implementation, the main component of the bonding oxide is SiO₂, correspondingly, the bonding oxide dispersion liquid is SiO₂ dispersion liquid, components of the SiO₂ dispersion liquid are SiO₂ particles and water, an average particle diameter of the SiO₂ particles ranges from 1 nm to 100 nm, and the SiO₂ particles are uniformly dispersed in the water. Compared with using a silicate solution (potassium silicate or sodium silicate) and an electrolyte solution (such as barium nitrate or strontium nitrate) as a precipitation solution, the embodiment of the present application directly uses the bonding oxide in the bonding oxide dispersion liquid as a bonding agent, the fluorescent powder layer is formed through adhesion of the nano-particles and a bonding effect between the nano-particles, forming the bonding agent through a reaction of the silicate solution and the electrolyte solution is not need, so that there may be fewer residual impurity ions (such as K, Na, Sr and Ba) or impurity components in the bonding oxide, absorption of the impurity ions or the impurity components for emitted ultraviolet light is reduced, and the ultraviolet light emitting intensity of the fluorescent powder layer is improved. As another implementation, the main component of the bonding oxide is Al₂O₃, correspondingly, the bonding oxide dispersion liquid is Al₂O₃ dispersion liquid, components of the Al₂O₃ dispersion liquid are Al₂O₃ particles and water, an average particle diameter of the Al₂O₃ particles ranges from 1 nm to 100 nm, and the Al₂O₃ particles are uniformly dispersed in the water. Compared with using an aluminate solution (potassium aluminate or sodium aluminate) and the electrolyte solution (such as barium nitrate or strontium nitrate) as a precipitation solution, the embodiment of the present application directly uses the bonding oxide in the bonding oxide dispersion liquid as a bonding agent, and there are fewer residual impurity components or impurity ions (such as K, Na, Sr and Ba) in the formed fluorescent powder layer, so that absorption of the impurity ions for emitted ultraviolet light may be reduced, and the ultraviolet light emitting intensity of the fluorescent powder layer is improved.
S102: fluorescent powder is poured into a glass shell containing the bonding oxide dispersion liquid. During actual preparation, a certain amount of fluorescent powder is weighed by a balance and poured into the glass shell of the bonding oxide. An average particle diameter of particles of the fluorescent powder ranges from 1 μm to 10 μm. Optionally, a ratio of the average particle diameter of the particles of the bonding oxide to the average particle diameter of the particles of the fluorescent powder ranges from 1:1000 to 1:100. The fluorescent powder includes at least one of the following: RePO₄:Z₁, LaP₅O₁₄:Z₁, CaSO₄:Z₁, SrSO₄:Z₁, NaYF₄:Z₁, LiYF₄:Z₁, KYF₄:Z₁, LiLaP₄O₁₂:Z₁, Y₂(SO₄)₃:Z₁, YAlO₃:Z₁ and YF₃:Z₁, where Re represents one or more types selected from Y, La, Lu, Sr, Gd, Sm and Ce, Z₁ represents a doping element, and the doping element contains a type of element selected from Nd, Pr and Bi. As another optional implementation, the fluorescent powder includes at least one of the following: RePO₄:Z₂, LaP₅O₁₄:Z₂, CaSO₄:Z₂, SrSO₄:Z₂, NaYF₄:Z₂, LiYF₄:Z₂, KYF₄:Z₂, LiLaP₄O₁₂:Z₂, Y₂(SO₄)₃:Z₂, YAlO₃:Z₂ and YF₃:Z₂, where Re represents one or more types selected from Y, La, Lu, Sr, Gd, Sm and Ce, Z₂ represents a doping element, the doping element contains two types of elements selected from Nd, Pr and Bi, and energy transfer may be formed among Nd, Pr and Bi under exciting of electron beams so as to improve the light-emitting intensity of the ultraviolet light. It needs to be noted that the fluorescent powder is pre-prepared fluorescent powder. Specifically, for example, a high temperature solid state method is used for preparing the fluorescent powder: raw materials of fluorescent powder are mixed, then ground, then calcined at a high temperature and ground, cleaned and dried after calcination is completed to obtain the needed fluorescent powder.
S103: the poured fluorescent powder and the bonding oxide dispersion liquid are stirred, and then still standing is performed for a certain period of time, so that the fluorescent powder is bonded to a surface of a bottom of the glass shell through a part of bonding oxide. The bonding oxide adopts nano-particles with a particle diameter ranging from 1 nm to 100 nm, surfaces of the nano-particles have many active hydroxyls, during a process of still standing, due to a nanometer adsorption effect and a gravity effect, the particles of a part of the bonding oxide may tightly adhere to the surfaces of the particles of the fluorescent powder and sedimented to the bottom of the glass shell along with the particles of the fluorescent powder, then the particles of the bonding oxide are connected and aggregated through an oxygen atom (namely, an oxygen bridge —O—) to form a network structure, so that the particles of the fluorescent powder may be bonded, in addition, the particles of the bonding oxide making contact the bottom of the glass shell are also connected to form a network structure, thus the particles of the fluorescent powder tightly adhere to the surface of the bottom of the glass shell, and namely, the particles of the fluorescent powder as well as the particles of the fluorescent powder and the surface of the bottom of the glass shell may be tightly bonded through the particles of the bonding oxide. It needs to be noted that the surface of the bottom of the glass shell in the present application refers to the internal surface of the fluorescent screen part. The time for still standing needs to be determined according to a size of the particles of the fluorescent powder, a size of the particles of the bonding oxide and a volume of the bonding oxide dispersion liquid and usually is in a range from 6 hours to 12 hours.
S104: the residual bonding oxide dispersion liquid in the glass shell is removed and drying is performed so that a fluorescent powder layer is formed on the surface of the bottom of the glass shell. After still standing is completed, the particles of the bonding oxide adhere to the particles of the fluorescent powder, so the particles of the fluorescent powder as well as the particles of the fluorescent powder and the surface of the glass shell are bonded together, the residual bonding oxide dispersion liquid is poured, the undried fluorescent powder layer may remain at the bottom of the glass shell and then dried to form the final fluorescent powder layer, and meanwhile, a surface of the bonding oxide is dehydrated during the drying process, so that the bonding property is further enhanced. During actual operation, removing the residual bonding oxide dispersion liquid in the glass shell 20 may be implemented in a manner of pouring or suction. Optionally, a drying temperature is less than or equal to 100° C., and drying time is in a range from 6 hours to 12 hours. The fluorescent powder layer is formed by stacking the particles of the fluorescent powder and the particles of the bonding oxide under the action of gravity, so there are obvious pores between the particles and there also are pores in the surface of the formed fluorescent powder layer and inside the fluorescent powder layer. Optionally, a maximum diameter of a section of each pore in the surface of and inside the fluorescent powder layer in a direction perpendicular to an axis “A” ranges from 1 μm to 10 μm. Optionally, the fluorescent powder layer has a thickness ranging from 5 μm to 50 μm.

In an optional embodiment, the method for preparing the fluorescent powder layer may include forming two or more fluorescent powder layers that are stacked, where at least one of the fluorescent powder layers is formed by using the above steps S101 to S104. Wavelengths of main emission peaks of ultraviolet light emitted by all the fluorescent powder layers under exciting of electron beams are different, and the wavelength of each main emission peak is 300 nm or below. Further, at least one of the wavelengths of the main emission peaks ranges from 190 nm to 250 nm.

During actual application, each of the two or more fluorescent powder layers is formed by using the above steps S101 to S104, wherein in step S102, types of fluorescent powder of all the fluorescent powder layers are different. It needs to be noted that the types of fluorescent powder being different means that the fluorescent powder layers at least include one different type of fluorescent powder. Specifically, for example, a method for forming a two-layer fluorescent powder layer includes: forming a first fluorescent powder layer by using the above steps S101 to S104; and forming a second fluorescent powder layer by using the above steps S101 to S104, wherein the first fluorescent powder layer and the second fluorescent powder layer at least include one different type of fluorescent powder.

In another optional embodiment, the method for preparing the fluorescent powder layer may include forming two or more subregion fluorescent powder layers, wherein at least one of the subregion fluorescent powder layers is formed by using the above steps S101 to S104. Wavelengths of main emission peaks of ultraviolet light emitted by the subregion fluorescent powder layers under exciting of the electron beams are different, and the wavelength of the main emission peak of the ultraviolet light emitted by at least one subregion fluorescent powder layer ranges from 190 nm to 250 nm. Optionally, the subregion fluorescent powder layers contain different types of fluorescent powder, and the types of fluorescent powder being different means that the subregion fluorescent powder layers at least include one different type of fluorescent powder. It may be understood that though a single-layer fluorescent powder layer includes two or more subregion fluorescent powder layers, the subregion fluorescent powder layers are located on the same layer, lower surfaces of the subregion fluorescent powder layers are coplanar approximately, upper surfaces of the subregion fluorescent powder layers are also coplanar approximately, and the subregion fluorescent powder layers jointly constitute a layer of fluorescent powder layer.

During actual application, the two or more subregion fluorescent powder layers are formed by using the above steps S101 to S104, and before step 101, the method further includes: putting a subregion mask plate into the glass shell 20, wherein the subregion mask plate exposes a to-be-formed subregion. Optionally, the subregion mask plate may be rigid or flexible. Specifically, for example, a method for forming two subregion fluorescent powder layers includes: putting a first subregion mask plate into the glass shell 20, wherein the first subregion mask plate exposes a first subregion; forming the first subregion fluorescent powder layer by using the steps S101 to S104; putting a second subregion mask plate into the glass shell 20, wherein the second subregion mask plate exposes a second subregion; and forming the second subregion fluorescent powder layer by using the steps S101 to S104; wherein the first subregion fluorescent powder layer and the second subregion fluorescent powder layer at least include one different type of fluorescent powder.

The method for preparing the fluorescent powder layer in the embodiment of the present application is that the bonding oxide dispersion liquid is directly used as a precipitation solution, components of the dispersion liquid are the bonding oxide and the water, meanwhile, the bonding oxide is nano-particles, and the fluorescent powder is bonded by using a nanometer effect and surface hydroxyl polymerization of the nano-particles so as to form the fluorescent powder layer. Compared with a fluorescent powder layer prepared by a conventional method, the preparation method in the embodiment of the present application is simpler and more convenient, the prepared fluorescent powder layer does not include an organic component, and meanwhile, there are fewer residual impurity ions (such as K, Na, Sr and Ba or impurity components), so that absorption of the impurity ions or the impurity components for emitted ultraviolet light may be reduced, and the light-emitting intensity of the fluorescent powder layer is improved.

FIG. 12 shows a surface SEM diagram of a fluorescent powder layer in an embodiment of the present application. It may be seen from the figure that a surface of the fluorescent powder layer has different-sized fluorescent powder particles, and an average particle diameter of the particles of the fluorescent powder ranges from 1 μm to 10 μm. The surface of the fluorescent powder is uneven and has pores, and a size of a largest pore ranges from 1 μm to 10 μm.

As shown in FIG. 5, a light-emitting structure layer 40 in the embodiment of the present application further includes a conductive layer 42, and the conductive layer 42 is arranged on the fluorescent powder layer 41 and configured to conduct negative charges accumulated on the surface of the fluorescent powder layer 41, so that reduction of energy of the electron beams due to a repulsion action caused by the accumulated negative charges to the electron beams is avoided.

Optionally, the conductive layer 42 may be an aluminum film layer. Optionally, the aluminum film layer has a thickness ranging from 200 nm to 400 nm. The aluminum film layer may form a reflecting surface, and the ultraviolet light emitted by the fluorescent powder layer 41 may be reflected to an external surface of the fluorescent screen part 21, so that the light-emitting intensity may be enhanced.

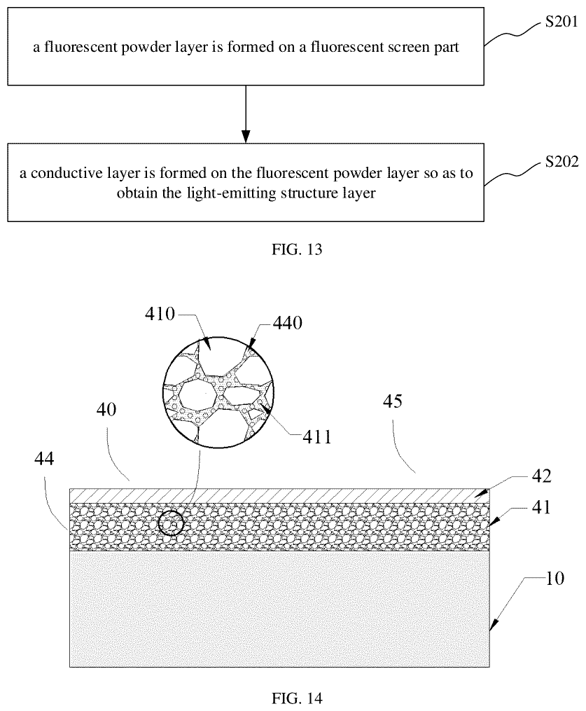

As shown in FIG. 13, an embodiment of the present application further provides a method for preparing a light-emitting structure layer, including:
S201: a fluorescent powder layer is formed on a fluorescent screen part. Specifically, the fluorescent powder layer may be formed by using the steps in the embodiment of the method for preparing the fluorescent powder layer.
S202: a conductive layer is formed on the fluorescent powder layer so as to obtain the light-emitting structure layer.

Specifically, forming the conductive layer on the fluorescent powder layer includes:
forming an organic film layer on the fluorescent powder layer. There are pores inside the fluorescent powder layer, directly forming the conductive layer on the fluorescent powder layer may cause a phenomenon of “fluorescent powder turning dark”, and as the surface of the fluorescent powder layer is uneven, if the conductive layer is directly formed on a surface of the fluorescent powder layer, specular reflection is hardly formed, and finally, the light-emitting intensity is affected. In the embodiment of the present application, a layer of organic film may be formed on the fluorescent powder layer so as to avoid an unfavorable influence caused by directly forming the conductive layer. It needs to be noted that “fluorescent powder turning dark” means that as there are many pores in hundreds of nanometers or even a few microns inside the fluorescent powder layer, directly forming the conductive layer on the fluorescent powder layer may cause particles of the conductive layer to enter the pores and be mixed with the particles of the fluorescent powder, so the phenomenon of the fluorescent powder layer turning dark is caused. During “fluorescent powder turning dark”, the particles of the conductive layer may powerfully absorb emitted ultraviolet light, and consequently, the light-emitting intensity of the fluorescent powder layer is severely affected. Specifically, the fluorescent powder layer is wetted with pure water, so a smooth film-forming surface is formed on the uneven surface of the fluorescent powder layer and surface tension of a solid powder layer is reduced, which is conducive to spreading an organic film solution thereon; then the organic film solution is added into the glass shell so as to form a smooth thin film on the surface of the fluorescent powder layer, wherein the surface of the fluorescent powder layer may be coated with the organic film solution in a manner of spray coating or spin coating; and finally, an organic film on the surface of the fluorescent powder is dried to form an organic film layer. The organic film solution mainly includes a film forming matter, a solvent and a plasticizer. The film forming matter is a basic material for forming the organic film and may be nitrocellulose. The solvent is a main component of a volatile part of the organic film solution and may be butyl acetate. The plasticizer is configured to improve flexibility of the organic film and may be dimethyl phthalate. The organic film solution is greatly susceptible to components, a temperature and a humidity, an environment condition needs to be strictly controlled during storage and use processes, otherwise, a formed organic film plane is prone to being non-uniform and having many pin holes, which may affect forming of the subsequent conductive layer.

A first conductive layer is formed on the organic film layer. The first conductive layer may be an aluminum film layer and has a thickness ranging from 100 nm to 200 nm. Specifically, the first conductive layer may be formed on the organic film layer in a manner of evaporation.

The organic film layer is removed. Specifically, the glass shell is heated at 200° C. to 400° C. so as to remove the organic film layer, so that the first conductive layer directly covers the fluorescent powder layer. Optionally, oxygen is fed into a drying oven during a heating process, and a concentration of oxygen in the drying oven is greater than 50%. An organic matter has strong absorption for ultraviolet light, especially for ultraviolet light of 250 nm or below, organic matter residues may severely affect the light-emitting intensity of the fluorescent powder layer, and the concentration of the oxygen increases by feeding oxygen into the drying oven, so that a hydrocarbon compound in the organic matter may be fully converted to CO₂ and H₂O, then the organic matter residues are reduced, and the light-emitting intensity is improved.

A second conductive layer is formed on the first conductive layer, so as to obtain the light-emitting structure layer. The second conductive layer may be an aluminum film layer and has a thickness ranging from 100 nm to 200 nm. Specifically, the second conductive layer may be formed on the first conductive layer in a manner of evaporation. Gas may be released during a process of heating and removing the organic film layer to cause small bumps or pin holes on the conductive layer, in addition, a surface of the conductive layer is prone to being contaminated by oxidation during the heating process, light reflection efficiency of the conductive layer is reduced, and the light-emitting efficiency is ultimately affected. The conductive layer in the present application is formed twice; at the first time, the organic film is used as a substrate to form the first conductive layer, then after the organic film is removed, the second conductive layer is formed on the first conductive layer, so though the first conductive layer is contaminated by oxidation or has pin holes, the second conductive layer may remedy a defect of the first conductive layer, and thus the finally formed conductive layer has a bright and smooth light reflection surface.

In the method for preparing the light-emitting structure layer in the embodiment of the present application, the fluorescent powder layer directly uses the bonding oxide dispersion liquid as the precipitation solution, and there are fewer residual impurity ions, so that absorption of the impurity ions for ultraviolet light may be reduced; the conductive layer is formed twice, so that the bright and smooth reflection surface may be formed; and the finally prepared light-emitting structure layer has a higher light-emitting intensity.

As shown in FIG. 14, in an optional embodiment, a light-emitting structure layer 40 further comprises a filling oxide 440, which is configured to fill a surface and internal pores of a fluorescent powder layer 41. Optionally, a structural layer formed after the fluorescent powder layer 41 is filled with the filling oxide 440 is defined as a first structure layer 44, that is, the first structure layer 44 comprises the fluorescent powder layer 41 and the filling oxide 440. Optionally, the filling oxide 440 is an inorganic material and is composed of inorganic particles. Optionally, at least part of the filling oxide 440 is filled in the surface and internal pores of the fluorescent powder layer 41.

Optionally, a ratio of an average particle size of the filling oxide 440 to an average particle size of the fluorescent powder particles ranges from 1:1000 to 1:100. The particle size of the filling oxide 440 is much smaller than the particle size of the fluorescent powder particles. By filling the fluorescent powder layer 41 with the filling oxide 440, the sizes of the surface and internal pores of the fluorescent powder layer 41 can be significantly reduced, thereby effectively reducing the phenomenon of “fluorescent powder blackening.” Optionally, the particles of the filling oxide 440 are nanoparticles having an average particle size ranging from 1 nm to 50 nm.

Optionally, the structural layer formed after the fluorescent powder layer 41 is filled with the filling oxide 440 is defined as the first structure layer 44, wherein the first structure layer 44 comprises fluorescent powder particles, bonding oxide particles, and filling oxide particles, and wherein a maximum diameter of a section of internal pores of the first structure layer 44 in a direction parallel to an inner surface of a fluorescent screen part 21 is less than 1 μm. Further, the maximum diameter of the section of the internal pores of the first structure layer 44 in a direction parallel to the inner surface of the fluorescent screen part 21 is less than or equal to 50 nm. In the present application, the internal pores of the fluorescent powder layer are filled with a filling oxide composed of nanoparticles, thereby reducing the size of the internal pores of the fluorescent powder layer. A conductive layer can be directly formed on the fluorescent powder layer without the use of an organic film, thereby avoiding organic residue caused by the organic film, reducing the absorption of ultraviolet light, and simultaneously, reducing the phenomenon of “fluorescent powder blackening” to improve the luminous intensity. Moreover, after the internal pores of the fluorescent powder layer are filled with the filling oxide, a light guide structure composed of the filling oxide can be formed, so that light generated by the fluorescent powder layer can be transmitted and emitted through the light guide structure, effectively reducing loss of ultraviolet light during the transmission process in the internal pores and thus improving the luminous intensity.

In an optional embodiment, a surface of a first structure layer 44 is composed of fluorescent powder particles, bonding oxide particles, and filling oxide particles. Compared with a surface of the fluorescent powder layer 41, since the filling oxide particles have a particle size much smaller than that of the fluorescent powder particles, the surface of the first structure layer 44 formed after the filling oxide particles fill the surface of the fluorescent powder layer 41 becomes flatter and denser.

In another optional embodiment, a surface of the first structure layer 44 is composed of the filling oxide particles, that is, the filling oxide 440 not only fills the surface and internal pores of the fluorescent powder layer 41, but also covers the surface of the fluorescent powder layer 41, thereby forming a smooth and dense surface of the first structure layer 44. Optionally, the surface of the first structure layer 44 has crack-like pores, and a maximum width of the pores is less than 1 μm.

Optionally, a conductive layer 42 is arranged on the first structure layer 44. The filling oxide 440 significantly reduces the sizes of the internal and surface pores of the fluorescent powder layer 41, wherein the pore sizes can be reduced from several microns to several tens of nanometers or even several nanometers, thereby greatly reducing the “fluorescent powder blackening” phenomenon caused by mixing between particles in the conductive layer and the fluorescent powder particles. Optionally, the conductive layer may be an aluminum film layer, and a thickness of the aluminum film layer ranges from 50 nm to 400 nm; further, the thickness of the aluminum film layer ranges from 50 nm to 100 nm. Due to the flatness and density of the surface of the first structure layer 44, a thinner conductive layer 42 can meet conductivity requirements, and a thinner conductive layer can also reduce absorption of electron beam energy, thereby improving luminous efficiency.

Optionally, a weight percentage of a main component of the filling oxide is greater than 99.9%, and a weight percentage of other impurity components is less than 0.1%. The main component of the filling oxide refers to the component with the highest proportion in the filling oxide 440, and it also serves as the functional component responsible for the filling effect in the filling oxide 440. Specifically, the main component refers to an oxide in the filling oxide 440, and specifically to a single type of oxide; the impurity components refer to impurities generated during preparation of the main component of the filling oxide. The filling oxide 440 contains only inorganic components and does not contain any organic components or organic residue components.

Optionally, the main component of the filling oxide may be SiO₂ or Al₂O₃. SiO₂ or Al₂O₃ is resistant to electron beam bombardment, has stable properties, and exhibits low absorption of ultraviolet light, thereby reducing an adverse effect on luminous intensity.

As an optional embodiment, a main component of the filling oxide is the same as a main component of the bonding oxide. In this way, a chemical bond can be formed between the filling oxide 440 and the bonding oxide 411 through an oxygen bridge (—O—), that is, the filling oxide 440 and the bonding oxide 411 can be chemically bonded to each other by linking via oxygen atoms, thereby improving the adhesion between the filling oxide 440 and the fluorescent powder layer 41. In one specific application, the main component of the bonding oxide is SiO₂, and the main component of the filling oxide is also SiO₂. In another specific application, the main component of the bonding oxide is Al₂O₃, and the main component of the filling oxide is also Al₂O₃.

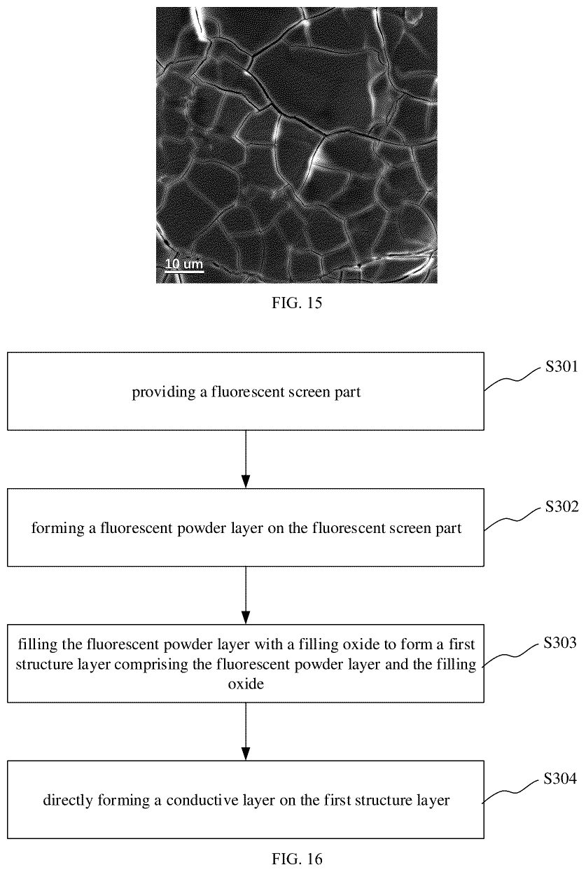

As shown in FIG. 15, which is an SEM image of a surface of the first structure layer according to one embodiment of the present application, it can be seen that, compared with a surface of a fluorescent layer, the surface of the first structure layer is flat and dense without obvious particulates. The surface of the first structure layer shown in the figure has crack-like pores, and a maximum width of the pores is less than 1 μm.

Based on the above, the present application also provides a fluorescent screen, comprising a fluorescent screen part and a first structure layer, wherein the first structure layer is arranged on the fluorescent screen part;
the first structure layer comprises a fluorescent powder layer and a filling oxide;
the fluorescent powder layer comprises fluorescent powder and a bonding oxide, wherein the bonding oxide is configured to bond the fluorescent powder particles with a surface of the fluorescent screen part;
the filling oxide is an inorganic material;
and at least part of the filling oxide is filled in internal pores of the fluorescent powder layer.

Optionally, the fluorescent screen further comprises a conductive layer, and the conductive layer is arranged on the first structure layer.

It is understandable that, in this embodiment, the fluorescent screen part may be the above-mentioned fluorescent screen part, or may be another supporting substrate, such that the first structure layer is arranged on the fluorescent screen part. Of course, the present application is not limited thereto, and a fluorescent screen configured according to this embodiment on any fluorescent screen part shall fall within the protection scope of the present application. In addition, other technical features recorded in this embodiment may be the same as those described in the previous embodiments, and thus will not be described repeatedly herein.

Specifically, as shown in FIG. 14, the fluorescent screen 45 comprises a fluorescent screen part 10, a first structure layer 44, and a conductive layer 42. In the fluorescent screen according to the present embodiment, the internal pores of the fluorescent powder layer are filled with the filling oxide, thereby significantly reducing the size of the internal pores of the fluorescent powder layer. As a result, during the process of directly forming the conductive layer on the fluorescent powder layer, the “fluorescent powder blackening” phenomenon can be effectively reduced, and the luminous intensity can be enhanced. Meanwhile, after the internal pores of the fluorescent powder layer are filled with the filling oxide, a light guide structure composed of the filling oxide can be formed, allowing the light generated by the fluorescent powder layer to be transmitted and emitted through the light guide structure, effectively reducing absorption and scattering of ultraviolet light during the transmission process in the internal pores, thereby enhancing the luminous intensity.

The present application further provides an ultraviolet cathode ray tube, comprising the fluorescent screen described in the above embodiments, an electronic gun, a tubular part configured to accommodate the electronic gun, and an electrical lead assembly electrically connected with the electronic gun;
wherein the tubular part is connected with the fluorescent screen part;
the electronic gun is arranged inside the tubular part and is configured to emit electron beams toward the fluorescent screen part;
a fluorescent powder layer in a first structure layer arranged on the fluorescent screen part emits light under exciting of the electron beams;
and the electronic gun is electrically connected with an external circuit through the electrical lead assembly.

As shown in FIG. 16, the present application further provides a preparation method of a fluorescent screen, comprising:
S301: providing a fluorescent screen part;
S302: forming a fluorescent powder layer on the fluorescent screen part;
specifically, the fluorescent powder layer can be formed by steps in the embodiments of the preparation method of the fluorescent powder layer as described above;
S303: filling the fluorescent powder layer with a filling oxide to form a first structure layer comprising the fluorescent powder layer and the filling oxide;
wherein at least part of the filling oxide is filled into internal pores of the fluorescent powder layer, and at least another part of the filling oxide is formed on a surface of the fluorescent powder layer.

The filling of the fluorescent powder layer with the filling oxide specifically comprises: applying a filling oxide dispersion onto the fluorescent powder layer, namely, pouring the filling oxide dispersion into the glass shell. The filling oxide dispersion comprises a filling oxide and water, and a liquid surface of the filling oxide dispersion is flush with or slightly higher than a surface of the fluorescent powder layer. The structure is then allowed to stand and dry for a certain period to enable the filling oxide to fill internal pores of the fluorescent powder layer. A concentration of the filling oxide in the filling oxide dispersion is less than or equal to 30%.

Here, the filling oxide is an inorganic material and is composed of inorganic particles. Optionally, a ratio of an average particle size of the filling oxide particles to an average particle size of the fluorescent powder particles ranges from 1:1000 to 1:100. Optionally, the filling oxide particles are nanoparticles having an average particle size ranging from 1 nm to 50 nm.

During the standing process, due to capillary force and gravitational force, the filling oxide dispersion is filled into the surface and internal pores of the fluorescent powder layer. After drying to remove the water content, the filling oxide particles remain, filling the surface and internal pores of the fluorescent powder layer and simultaneously forming a surface of the first structure layer that is denser and flatter than the original surface of the fluorescent powder layer.

Optionally, a weight percentage of a main component of the filling oxide is greater than 99.9%, and a weight percentage of other impurity components is less than 0.1%. The main component refers to the component with the highest proportion in the filling oxide and serves as the primary filling material. Specifically, the main component refers to an oxide, specifically a single type of oxide, while the impurity components refer to impurities generated during the preparation of the main component. The filling oxide contains only inorganic components and does not contain any organic components or organic residue.

As one embodiment, the filling oxide dispersion is a SiO₂ dispersion, with the corresponding main component of the filling oxide being SiO₂.

As another embodiment, the filling oxide dispersion is an Al₂O₃ dispersion, with the corresponding main component of the filling oxide being Al₂O₃.

The filling oxide dispersion used in this embodiment contains only the filling oxide and water without any other organic components, and the impurity ion content is very low (only including impurities generated during preparation of the main component), thus allowing effective filling of the pores in the fluorescent powder layer to form a denser and flatter surface, without introducing additional impurities.
S304: directly forming a conductive layer on the first structure layer.

Specifically, the conductive layer can be directly formed on the first structure layer by a vapor deposition process. Optionally, the conductive layer may be an aluminum film layer, and a thickness of the aluminum film layer ranges from 50 nm to 400 nm. Further, the thickness of the aluminum film layer may range from 50 nm to 100 nm.

Due to the flatness and density of the surface of the first structure layer, it is possible to directly form the conductive layer without forming an organic film, and a thinner conductive layer can satisfy the conductivity requirement.

The method of the present embodiment forms the conductive layer directly on the first structure layer, and compared with the conventional process of forming an organic film-forming the conductive layer-removing the organic film, the method of the present embodiment is simpler, more environmentally friendly, and avoids the problem of organic residue caused by removal of the organic film.

The preparation method of the fluorescent screen according to the present embodiment utilizes the filling oxide to fill the surface and internal pores of the fluorescent powder layer and forms a denser and flatter surface, thereby greatly reducing the size of the internal pores of the fluorescent powder layer.

Thus, the method can reduce or even avoid the “fluorescent powder blackening” phenomenon caused by mixing of particles in the conductive layer and fluorescent powder particles.

Compared with the process using an organic film, the preparation method of the present embodiment uses the filling oxide to fill the internal pores of the fluorescent powder layer, and then directly forms the conductive layer, resulting in a simpler and more environmentally friendly process. Additionally, the method avoids the issue of organic residue caused by the removal of an organic film, thereby reducing absorption of ultraviolet light by residual organic material and improving the luminous efficiency.

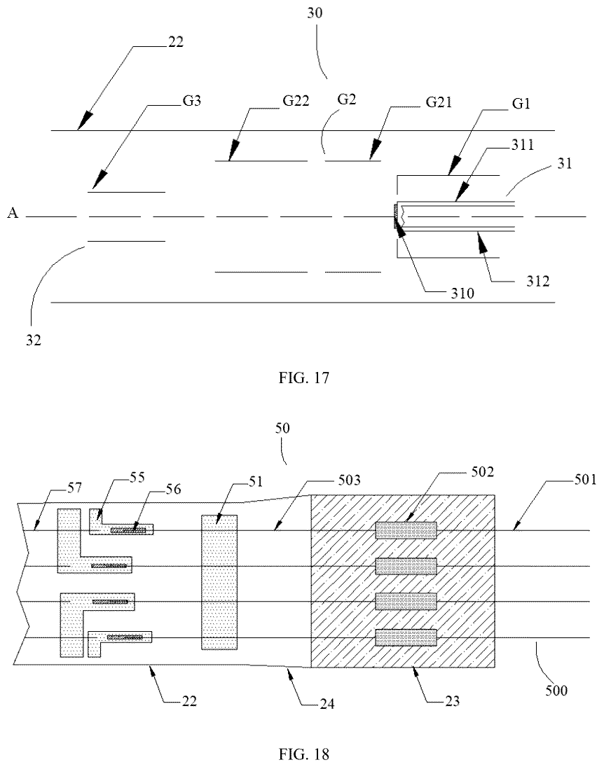

FIG. 17 is a schematic structural diagram of an electronic gun in an embodiment of the present application. The electronic gun 30 in the figure is an area projection type electronic gun and specifically includes a cathode assembly 31 and an electrode assembly 32. It needs to be noted that the area projection type electronic gun means that the electron beams emitted by the electronic gun to the fluorescent screen part are emitted in a manner of area projection.

The cathode 310 assembly 31 includes a cathode tube 311, a cathode 310 and a lamp filament 312. The cathode tube 311 is a barrel-shaped metal tube and includes a sealed end and an opening end, the cathode 310 is arranged on an external surface of the sealed end of the cathode tube 311, and the lamp filament 312 is arranged in the cathode tube 311 and close to the sealed end of the cathode tube 311. Optionally, the cathode 310 emits electrons to form an emitting surface of the cathode 310, the cathode 310 may be specifically a planar cathode, the planar cathode means that a material of the cathode 310 is made to be block-shaped and the electrons, when emitted, are emitted from a plane, the electron beams emitted by the planar cathode are more uniform, and the uniform cathode emitting surface is easier to form. Optionally, the shape of the planar cathode may be annular, the annular cathode is conducive to reducing density of electron beams in a middle of the emitting surface of the cathode 310, and thus uniformity of the electron beams is improved. Optionally, the material of the cathode 310 is an oxide, namely, the cathode 310 is an oxide cathode, the oxide cathode has advantages of a high melting point, large electrical resistivity, low work function, long service life and the like, and the embodiment of the present application uses the oxide cathode so that the electronic gun stably emits the electrons and the service life may be up to tens of thousands of hours. Further, the material of the cathode 310 is a mixture of BaCO₃, SrCO₃ and CaCO₃. Optionally, an external diameter of the cathode tube 311 is in a range of 1.6 mm+0.02 mm. During specific working, an electric current flows through the lamp filament 312 in the cathode assembly, the lamp filament 312 heats the cathode 310 on the external surface of the sealed end of the cathode tube 311, and when a temperature reaches a temperature needed for emitting the electrons by the cathode 310, the cathode 310 emits the electrons.

The electrode assembly 32 includes a plurality of metal barrels, and all the metal barrels are in axial symmetry along a longitudinal central axis “A”. Materials of the plurality of metal barrels are a non-magnetic metal material. Further, the materials of the plurality of metal barrels are non-magnetic stainless steel. Optionally, the electron beams emitted by the cathode 310 pass through the electrode assembly 32 to bombard the fluorescent screen part 21 in a manner of area projection, and a projection surface of area projection is an one-time inverted image of the emitting surface of the cathode 310. It needs to be noted that the electron beams bombarding the fluorescent screen part 21 in a manner of area projection means that the electron beams form a projection surface in a scattered manner to bombard the fluorescent screen part 21, and a focusing manner is opposite to the scattered manner and means that bombardment to the fluorescent screen is a point but not a plane.

The plurality of metal barrels include a cathode modulation region metal barrel G1, an electron beam modulation region metal barrel G2 and an electron beam acceleration region metal barrel G3. Optionally, the plurality of metal barrels are connected with independent input voltages respectively, so that their input voltages may be controlled independently and may be the same or not. Optionally, internal diameters of the plurality of metal barrels each range from 3 mm to 15 mm.

The number of electrons emitted by the cathode 310 may be adjusted by controlling an electric potential of the cathode modulation region metal barrel G1 and an electric potential of the cathode 310, and a magnitude of an electron beam current is changed. Optionally, the electric potential of the cathode modulation region metal barrel G1 ranges from 0 V to 20 V. Optionally, an electric potential of a cathode modulation region is greater than or equal to the electric potential of the cathode 310. The cathode tube 311 is sleeved with the cathode modulation region metal barrel G1, a small hole is formed in an end portion of the cathode modulation region metal barrel G1, and the small hole has a diameter ranging from 2 mm to 3 mm. Optionally, the cathode 310 is flush with or slightly protrudes out of the end portion of the cathode modulation region metal barrel G1, namely, the cathode 310 is flush with or penetrates through the small hole of the end portion of the cathode modulation region metal barrel G1, so that influence of an electric field of the cathode modulation region on an emitting direction of the electron beams may be reduced, and thus uniformity of the emitting surface of the cathode 310 is improved. Optionally, a distance for which the cathode 310 protrudes out of the end portion of the cathode modulation region metal barrel G1 ranges from 0.01 mm to 0.03 mm.

The electron beam modulation region metal barrel G2 is configured to control an electron beam morphology in the region. Optionally, the electron beam modulation region metal barrel G2 includes a plurality of sub-beam modulation region metal barrels, each sub-beam modulation region metal barrel is connected with an independent input voltage, and their input voltages may be independently controlled and may be the same or not, so that the electron beam morphology in the region may be controlled accurately; and in addition, the plurality of sub-beam modulation region metal barrels can more conveniently and more flexibly control the electron beam morphology. Optionally, gaps between the sub-beam modulation region metal barrels are the same; and further, each gap between the sub-beam modulation region metal barrels is less than or equal to 1 mm. Optionally, a gap between the cathode modulation region metal barrel G1 and a sub-beam modulation region metal barrel adjacent to the cathode modulation region metal barrel G1 is less than or equal to 1 mm. Optionally, internal diameters of the sub-beam modulation region metal barrel are the same; and further, the internal diameter of each sub-beam modulation region metal barrel is in a range of 10±0.1 mm. Optionally, the internal diameter of the sub-beam modulation region metal barrel adjacent to the cathode modulation region metal barrel G1 is greater than or equal to the internal diameter of the cathode modulation region metal barrel G1, so that a curve of an electric field force may be in a divergent state, and the electron beams are more conveniently controlled to be uniformly divergent. Optionally, an electric potential of each sub-beam modulation region metal barrel ranges from 0 V to 50 V. Optionally, an electric potential of the sub-beam modulation region metal barrel adjacent to the cathode modulation region is greater than the electric potential of the cathode modulation region metal barrel. By controlling the internal diameter and the electric potential of the metal barrel, the electron beam morphology may be conveniently adjusted and thus the electron beams are uniformly divergent. Optionally, in the two adjacent sub-beam modulation region metal barrels, an electric potential of the sub-beam modulation region metal barrel away from the cathode 310 is greater than or equal to an electric potential of the sub-beam modulation region metal barrel close to the cathode 310, so that an electric field direction may be better adjusted, and the electron beam morphology may be better controlled. Optionally, in the two adjacent sub-beam modulation region metal barrels, a length of the sub-beam modulation region metal barrel away from the cathode 310 is greater than a length of the sub-beam modulation region metal barrel close to the cathode 310. Optionally, the electric potential of the electron beam modulation region metal barrel G2 may be controlled in a pulse manner so as to implement light-emitting of the light-emitting structure layer in a pulse manner. It needs to be noted that the gap between the metal barrels refers to a distance between two adjacent end faces of the two metal barrels. In the embodiment of the present application, the electron beam morphology may be conveniently and flexibly controlled through a size and the electric potential of the electron beam modulation region metal barrel; and the light-emitting frequency of the light-emitting structure layer may be controlled by adjusting a pulse frequency of the electric potential of the electron beam modulation region metal barrel, and thus it has wide application prospects in the field of ultraviolet communication and the like. Further, the electron beam modulation region metal barrel G2 includes two sub-beam modulation region metal barrels and specifically includes the first sub-electron-beam modulation region metal barrel G21 and the second sub-electron-beam modulation region metal barrel G22. Through cooperation control of the two sub-beam modulation region metal barrels, on the one hand, the electron beam morphology may be flexibly adjusted through the electric potential and the size of the metal barrel, and on the other hand, the number of electrical leads connected thereto may be reduced so that a reject ratio of air leakage between the electrical leads and the sealing part is reduced.

The electron beam acceleration region metal barrel G3 is configured to form a strong electric field, so that the electron beams are accelerated to an extremely high speed and then bombard the fluorescent screen part 21. Optionally, an electric potential of the electron beam acceleration region metal barrel G3 is a high-voltage electric potential, which specifically ranges from 5 kV to 20 kV. Optionally, an internal diameter of the electron beam acceleration region metal barrel G3 is less than an internal diameter of the sub-beam modulation region metal barrel adjacent to the electron beam acceleration region metal barrel G3, the electron beams passing through the electron beam acceleration region metal barrel are projected in a manner of area projection, and the projection surface of area projection is an one-time inverted image of the emitting surface of the cathode. In the embodiment of the present application, the internal diameter of the electron beam acceleration region metal barrel is less than the internal diameter of the sub-beam modulation region metal barrel adjacent thereto, so that a range of the electric field is reduced; the electron beam direction is further modulated through the electric potential, so the electron beams may be focused and then diverged to form an one-time inverted image, and uniformity of the electron beams is improved; and finally, the fluorescent screen part is bombarded in a manner of area projection, and the final projection surface of area projection of the electron beams is the one-time inverted image of the emitting surface of the cathode.

Optionally, a gap between the electron beam acceleration region metal barrel G3 and a sub-beam modulation region metal barrel adjacent to the electron beam acceleration region metal barrel G3 ranges from 1 mm to 3 mm.

Specifically, as shown in FIG. 18, the electrode assembly 32 includes the cathode modulation region metal barrel G1, the electron beam modulation region metal barrel G2 and the electron beam acceleration region metal barrel G3. The electron beam modulation region metal barrel G2 includes the first sub-electron-beam modulation region metal barrel G21 and the second sub-electron-beam modulation region metal barrel G22. Specifically, a size relationship between the internal diameters of the metal barrels is G3<G1<G21=G22. In a power-on state, the electric potential of the cathode modulation region metal barrel G1 ranges from 0 V to 20 V; and both electric potentials of G21 and G22 are greater than the electric potential of G1, and the electric potentials of G21 and G22 range from 0 to 50 V; and G3 is in a high-voltage electric potential, specifically, ranging from 5 kV to 20 kV. A gap between G1 and G21 is 0.5 mm, a gap between G21 and G22 is 0.5 mm, and a gap between G22 and G3 is 2 mm. In the plurality of metal barrels, a length of G1 is 8 mm, a length of G21 is 5 mm, a length of G22 is 8.5 mm, and a length of G3 is 5 mm.

As shown in FIG. 1, the cathode ray tube 10 in the embodiment of the present application further includes an electrical lead assembly 50, and the electronic gun 30 is electrically connected with the outside through the electrical lead assembly 50.

FIG. 15 is a schematic diagram of an electrical lead assembly in an embodiment of the present application. In the figure, the electrical lead assembly 50 penetrates through the sealing part 23, so as to expose an end of the electrical lead assembly 50 from the sealing part 23 and make the other end of the electrical lead assembly 50 be connected with the electronic gun 30 in the tubular part 22, and the electronic gun 30 is connected with an external circuit through the electrical lead assembly 50. Optionally, the electrical lead assembly 50 includes a plurality of electrical leads 500, at least a part of the plurality of electrical leads are electrically connected with the electrode assembly 32 and/or the cathode assembly 31, and the electrode assembly 32 and/or the cathode assembly 31 are electrically connected with the external circuit through the electrical leads. Specifically, the plurality of metal barrels in the electrode assembly 32 are connected with the different electrical leads respectively, the different electrical leads are connected with external independent input voltages respectively, and thus the input voltages of the plurality of metal barrels may be independently controlled respectively.

Optionally, the electrical lead assembly 50 at least includes four electrical leads.

Optionally, at least one electrical lead is electrically connected with the electron beam acceleration region metal barrel. By electrically connecting the electrical leads with the electron beam acceleration region metal barrel, the external circuit may provide a high-voltage electric potential ranging from 5 kV to 20 kV for an electron beam acceleration region directly through the electrical leads, connection is more convenient and simpler, and thus an anode metal bar for high-voltage electric potential connection may be prevented from being additionally arranged on the glass shell 20.

Optionally, the electrical lead 500 includes an upper-end metal wire 501, a middle metal sheet 502 and a lower-end metal wire 503. The middle metal sheet 502 is connected with the upper-end metal wire 501 and the lower-end metal wire 503 respectively. The middle metal sheet 502 is sealed in the sealing part 23. A part of the upper-end metal wire 501 is sealed in the sealing part 23, and the other part of the upper-end metal wire extends out the sealing part 23 to be connected with the external circuit. A part of the lower-end metal wire 503 is sealed in the sealing part 23, and the other part of the lower-end metal wire is connected with the cathode assembly 31 and/or the electrode assembly 32. In a case that the electrical lead assembly 50 includes the plurality of electrical leads 500, each of the plurality of electrical leads 500 may have the same structure; each electrical lead 500 may include the upper-end metal wire 501, the middle metal sheet 502 and the lower-end metal wire 503; and certainly, the embodiment of the present application does not exclude a case that the plurality of electrical leads 500 have different structures. A sealing condition of the sealing part 23 may directly affect air-tightness inside the glass shell, a thermal expansion coefficient of the electrical lead is greatly different from a thermal expansion coefficient of the glass shell, and the metal sheet may be better sealed in the sealing part through the thin metal sheet and the flat-shaped sealing part, so as to maintain good air-tightness.

Optionally, an edge of the middle metal sheet 502 is in a blade shape in the axis “A” direction. A stretching force may be generated during a process of forming the sealing part 23, and the blade-shaped edge of the middle metal sheet 502 in a stretching direction of the sealing part 23 may generate a slight plastic deformation along a stretching force, so that the middle metal sheet 502 may be better sealed by the sealing part 23 to form good air-tightness. It needs to be noted that in the embodiment of the present application, the blade shape is specifically embodied as gradually reducing a thickness of the edge of the middle metal sheet, for example, a position of the middle metal sheet close to the edge has a thickness of 0.6 mm, a position at the very edge has a thickness of 0.1 mm, and the thickness from the position close to the edge to the position at the very edge is gradually reduced.

Optionally, the electrical lead assembly 50 further includes a fixing column 51, the lower-end metal wire 503 penetrates through the fixing column 51 to be connected with the middle metal sheet 502, and the fixing column 501 is configured to fix the electrical leads so as to prevent the electrical leads from bending and deforming and avoid mutual contact between the plurality of electrical leads. Optionally, a material of the fixing column 51 is quartz glass, and the quartz glass is more thermal-insulating and resistant to a high temperature, so as to avoid an influence of high temperature heating.

Optionally, the electrical lead assembly 50 further includes a connecting sheet 55, and the lower-end metal wire 503 is electrically connected with the electronic gun 30 through the connecting sheet 55. Specifically, the lower-end metal wire 503 is connected with the connecting sheet 55 through welding, and the connecting sheet 55 is connected with the electronic gun 30 through a metal wire 57. Optionally, the connecting sheet 55 is in an L shape, so that the occupied space is smaller and connection is more convenient. Optionally, a material of the electrical lead 500 is molybdenum. Optionally, the material of the connecting sheet 55 is stainless steel, and a material of the metal wire 57 is stainless steel. Optionally, the electrical lead assembly 50 further includes a buffer metal sheet 56. Specifically, the lower-end metal wire 503 is connected with the connecting sheet 55 through the buffer metal sheet 56, the buffer metal sheet 56 is welded to the connecting sheet 55, the lower-end metal wire 503 is welded to the buffer metal sheet 56, and the connecting sheet 55 is connected with the electrode assembly 32 or the cathode assembly 31 through the metal wire 57. Optionally, a material of the buffer metal sheet 56 is nickel. Through the buffer metal sheet and the connecting sheet, a situation of unfavorable connection caused by different thermal expansion coefficients of materials may be reduced, and connection stability is improved.

Optionally, diameters of sections of the upper-end metal wire 501 and the lower-end metal wire 503 are each greater than a center thickness of the middle metal sheet 502.

Optionally, the diameters of the sections of the upper-end metal wire 501 and the lower-end metal wire 503 are each in a range from 0.5 mm to 0.8 mm.

Optionally, the center thickness of the middle metal sheet 502 ranges from 0.1 mm to 0.4 mm. Optionally, the middle metal sheet 502 is a rectangular metal sheet, a long edge of the rectangular metal sheet extends in the axis “A” direction, and a length of the long edge is greater than or equal to 10 mm. It needs to be understood that the middle metal sheet in the embodiment of the present application has a change of the thickness in the blade-shaped edge position but has basically the same thickness in other positions. The center thickness of the middle metal sheet 502 refers to the thickness of a region of the middle metal sheet 502 except the blade-shaped edge position.

The ultraviolet cathode ray tube provided by the embodiment of the present application includes the glass shell, the light-emitting structure layer, the electronic gun and the electrical lead assembly electrically connected with the electronic gun, and ultraviolet light is emitted in a manner that the electronic gun emits the electron beams to excite the light-emitting structure layer. The ultraviolet cathode ray tube of the present application is high in light-emitting efficiency, high in light-emitting energy, free of pollution, low in cost and easy to massively produce.

The specific embodiments described above further illustrate the purpose, technical solutions and beneficial effects of the present application. It should be understood that the above description is only a specific embodiment of the embodiments of the present application and is not intended to limit the scope of protection of the present application. Any modifications, equivalent substitutions, improvements, etc. made within the spirit and principles of the present application should be included in the scope of protection of the present application. The technical features in the above specific embodiments can be combined arbitrarily without conflict.

1. An ultraviolet cathode ray tube, comprising:
a glass shell, a light-emitting structure layer and an electronic gun;
wherein the glass shell comprises a tubular part configured to contain the electronic gun and a fluorescent screen part connected with the tubular part;
the electronic gun is arranged inside the tubular part and configured to emit electron beams to the fluorescent screen part;
the light-emitting structure layer comprises a fluorescent powder layer and a conductive layer, and the fluorescent powder layer is arranged on the fluorescent screen part and emits ultraviolet light under exciting of the electron beams;
wherein a wavelength of a main emission peak of the ultraviolet light emitted by the fluorescent powder layer ranges from 190 nm to 250 nm;
wherein the main emission peak refers to an emission peak with the maximum light-emitting intensity of the fluorescent powder layer under exciting of the electron beams;
the glass shell further comprises a sealing part connected with an end of the tubular part away from the fluorescent screen part, and the sealing part is configured to implement sealing an end opening of the end of the tubular part away from the fluorescent screen part;
wherein materials of the fluorescent screen part, the tubular part and the sealing part are quartz glass or sapphire crystal;
wherein the sealing part is formed by deforming an end of the tubular part;
and wherein the glass shell encloses an airtight internal space by the fluorescent screen part, the tubular part and the sealing part, and an internal space of the glass shell is in a vacuum state.

2. The ultraviolet cathode ray tube according to claim 1, wherein the ultraviolet light emitted by the fluorescent powder layer with a wavelength in a range less than or equal to 300 nm further comprises at least one auxiliary emission peak, and a ratio of a light-emitting intensity of the auxiliary emission peak to a light-emitting intensity of the main emission peak is greater than or equal to 1:10.

3. The ultraviolet cathode ray tube according to claim 2, wherein the auxiliary emission peak comprises a first auxiliary emission peak;
a wavelength of the main emission peak ranges from 220 nm to 230 nm; and a wavelength of the first auxiliary emission peak ranges from 275 nm to 285 nm.

4. The ultraviolet cathode ray tube according to claim 1, wherein the emitted ultraviolet light with a wavelength in a range less than or equal to 300 nm further comprises two or more auxiliary emission peaks, and a ratio of a light-emitting intensity of any one of the two or more auxiliary emission peaks to the light-emitting intensity of the main emission peak is greater than or equal to 1:10.

5. The ultraviolet cathode ray tube according to claim 4, wherein the auxiliary emission peaks comprise a first auxiliary emission peak, a second auxiliary emission peak and a third auxiliary emission peak;
wherein a wavelength of the main emission peak ranges from 230 nm to 240 nm;
a wavelength of the first auxiliary emission peak ranges from 240 nm to 250 nm;
a wavelength of the second auxiliary emission peak ranges from 260 nm to 270 nm; and
a wavelength of the third auxiliary emission peak ranges from 270 nm to 280 nm.

6. The ultraviolet cathode ray tube according to claim 4, wherein the auxiliary emission peaks comprise a first auxiliary emission peak and a second auxiliary emission peak;
wherein a wavelength of the main emission peak ranges from 190 nm to 200 nm;
a wavelength of the first auxiliary emission peak ranges from 270 nm to 280 nm; and
a wavelength of the second auxiliary emission peak ranges from 235 nm to 245 nm.

7. The ultraviolet cathode ray tube according to any one of claims 1 to 6, wherein an integrated emission intensity of the ultraviolet light emitted by the fluorescent powder layer with a wavelength in a range from 190 nm to 250 nm is greater than an integrated emission intensity with a wavelength in a range from 250 nm to 300 nm.

8. The ultraviolet cathode ray tube according to claim 1, wherein the fluorescent powder layer comprises fluorescent powder, and the fluorescent powder comprises at least one of the following: RePO₄:Z₁, LaP₅O₁₄:Z₁, CaSO₄:Z₁, SrSO₄:Z₁, NaYF₄:Z₁, LiYF₄:Z₁, KYF₄:Z₁, LiLaP₄O₁₂:Z₁, Y₂(SO₄)₃:Z₁, YAlO₃:Z₁ and YF₃:Z₁;
wherein Re represents one or more types selected from Y, La, Lu, Sr, Gd, Sm and Ce, Z₁ represents a doping element, and the doping element contains one type of element selected from Nd, Pr and Bi.

9. The ultraviolet cathode ray tube according to claim 1, wherein the fluorescent powder layer comprises fluorescent powder, and the fluorescent powder comprises at least one of the following: RePO₄:Z₂, LaP₅O₁₄:Z₂, CaSO₄:Z₂, SrSO₄:Z₂, NaYF₄:Z₂, LiYF₄:Z₂, KYF₄:Z₂, LiLaP₄O₁₂:Z₂, Y₂(SO₄)₃:Z₂, YAlO₃:Z₂ and YF₃:Z₂;
wherein Re represents one or more types selected from Y, La, Lu, Sr, Gd, Sm and Ce, Z₂ represents a doping element, and the doping element contains two types of elements selected from Nd, Pr and Bi.

10. The ultraviolet cathode ray tube according to claim 8 or 9, wherein the fluorescent powder layer is a single-layer fluorescent powder layer comprising two or more kinds of the fluorescent powders.

11. The ultraviolet cathode ray tube according to claim 10, wherein the single-layer fluorescent powder layer comprises two or more sub-regional fluorescent powder layers, and types of the fluorescent powder contained in the sub-regional fluorescent powder layers are different.

12. The ultraviolet cathode ray tube according to claim 11, wherein wavelengths of the main emission peaks of ultraviolet light emitted by the sub-regional fluorescent powder layers under exciting of the electron beams are different, and a main emission peak wavelength of ultraviolet light emitted by at least one of the sub-regional fluorescent powder layers ranges from 190 nm to 250 nm.

13. The ultraviolet cathode ray tube according to claim 8 or 9, wherein the fluorescent powder layer comprises two or more stacked fluorescent powder layers, and types of the fluorescent powder contained in the respective fluorescent powder layers are different.

14. The ultraviolet cathode ray tube according to claim 13, wherein the main emission peaks of ultraviolet light emitted by the respective fluorescent powder layers under exciting of the electron beams are different, and a wavelength of the main emission peak of at least one of the fluorescent powder layers ranges from 190 nm to 250 nm.

15. An ultraviolet cathode ray tube, comprising:
a glass shell, a light-emitting structure layer, an electronic gun and an electrical lead assembly electrically connected with the electronic gun;
wherein the glass shell comprises a tubular part configured to contain the electronic gun and a fluorescent screen part connected with the tubular part;
the electronic gun is arranged inside the tubular part and configured to emit electron beams to the fluorescent screen part;
the light-emitting structure layer is arranged on the fluorescent screen part and emits ultraviolet light under exciting of the electron beams;
the electronic gun is electrically connected with the outside through the electrical lead assembly;
the glass shell further comprises a sealing part connected with an end of the tubular part away from the fluorescent screen part, the sealing part being configured to implement sealing an end opening of the end of the tubular part away from the fluorescent screen part and to implement leading the electrical lead assembly from an interior of the tubular part to an exterior of the tubular part;
the electrical lead assembly penetrates through the sealing part so as to expose one end of the electrical lead assembly from the sealing part and to make another end of the electrical lead assembly connected with the electronic gun inside the tubular part;
materials of the fluorescent screen part, the tubular part and the sealing part are quartz glass or sapphire crystal;
the sealing part is formed by deforming an end of the tubular part;
and the glass shell encloses an airtight internal space by the fluorescent screen part, the tubular part and the sealing part, and an internal space of the glass shell is in a vacuum state.

16. The ultraviolet cathode ray tube according to claim 15, wherein a thickness of the sealing part is greater than a wall thickness of the tubular part and less than an internal diameter of the tubular part.

17. The ultraviolet cathode ray tube according to claim 15, wherein the electrical lead assembly comprises a plurality of electrical leads;
each electrical lead comprises an upper end metal wire, a middle metal sheet, and a lower end metal wire, wherein two ends of the middle metal sheet are respectively connected with the upper end metal wire and the lower end metal wire;
and the middle metal sheet is sealed inside the sealing part.

18. The ultraviolet cathode ray tube according to claim 17, wherein an edge of the middle metal sheet along an axial direction is in a blade shape.

19. The ultraviolet cathode ray tube according to claim 17, wherein cross-sectional diameters of the upper end metal wire and the lower end metal wire each range from 0.5 mm to 0.8 mm, and a central thickness of the middle metal sheet ranges from 0.1 mm to 0.4 mm.

20. The ultraviolet cathode ray tube according to claim 17, wherein the electrical lead assembly further comprises a fixing post, and the lower end metal wire of each of the plurality of electrical leads penetrates through the fixing post.

21. The ultraviolet cathode ray tube according to claim 15, wherein an inner surface profile of the fluorescent screen part is circular.

22. The ultraviolet cathode ray tube according to claim 15, wherein the tubular part comprises a first cylindrical part;
and an inner surface of the first cylindrical part is perpendicular to an inner surface of the fluorescent screen part.

23. The ultraviolet cathode ray tube according to claim 22, wherein the first cylindrical part is connected with the fluorescent screen part.

24. The ultraviolet cathode ray tube according to claim 22, wherein the tubular part further comprises a conical part;
the conical part comprises a small opening end and a large opening end;
and the first cylindrical part is connected with the small opening end of the conical part.

25. The ultraviolet cathode ray tube according to claim 24, wherein the tubular part further comprises a second cylindrical part;
one end of the second cylindrical part is connected with the large opening end of the conical part, and another end of the second cylindrical part is connected with the fluorescent screen part;
and an internal diameter of the second cylindrical part is greater than an internal diameter of the first cylindrical part.

26. The ultraviolet cathode ray tube according to claim 25, wherein an inner surface of the second cylindrical part is perpendicular to the inner surface of the fluorescent screen part.

27. The ultraviolet cathode ray tube according to claim 25, wherein a ratio of a distance between an end surface of the small opening end of the conical part and an end surface of the large opening end of the conical part to a height of the second cylindrical part ranges from 0.5:1 to 2:1.

28. The ultraviolet cathode ray tube according to claim 27, wherein a height of the second cylindrical part is greater than or equal to 20 mm.

29. The ultraviolet cathode ray tube according to claim 24, wherein a ratio of a distance between an end surface of the small opening end of the conical part and an inner surface of the fluorescent screen part to a diameter of the inner surface of the fluorescent screen part ranges from 1:0.5 to 1:4.

30. The ultraviolet cathode ray tube according to claim 24, wherein the glass shell further comprises an exhaust part, the exhaust part being arranged on the tubular part; one end of the exhaust part is connected with an interior of the tubular part, and another end is sealed.

31. The ultraviolet cathode ray tube according to claim 30, wherein the exhaust part is arranged on the first cylindrical part.

32. The ultraviolet cathode ray tube according to claim 15, wherein the light-emitting structure layer comprises a fluorescent powder layer and a conductive layer, the fluorescent powder layer is arranged on an inner surface of the fluorescent screen part, and the conductive layer is arranged on the fluorescent powder layer;
the fluorescent powder layer emits ultraviolet light under exciting of the electron beams;
the fluorescent powder layer comprises fluorescent powder and a bonding oxide, and the bonding oxide is bonded between the fluorescent powder and the inner surface of the fluorescent screen part;
an average particle size of particles of the bonding oxide ranges from 1 nm to 100 nm;
and an average particle size of particles of the fluorescent powder ranges from 1 μm to 10 μm.

33. The ultraviolet cathode ray tube according to claim 32, wherein a weight percentage of a main component of the bonding oxide is greater than 99.9%;
wherein the main component of the bonding oxide refers to a component with the highest proportion in the bonding oxide.

34. The ultraviolet cathode ray tube according to claim 33, wherein the main component of the bonding oxide is the same as a main component of the inner surface of the fluorescent screen part;
wherein the main component of the inner surface of the fluorescent screen part refers to a component with the highest proportion in the inner surface of the fluorescent screen part.

35. The ultraviolet cathode ray tube according to claim 33, wherein a buffer layer is further arranged between the fluorescent screen part and the fluorescent powder layer, and a main component of the buffer layer is the same as the main component of the bonding oxide;
wherein the main component of the buffer layer refers to a component with the highest proportion in the buffer layer.

36. The ultraviolet cathode ray tube according to claim 33, wherein the main component of the bonding oxide is SiO₂ or Al₂O₃.

37. The ultraviolet cathode ray tube according to claim 15, wherein the electronic gun is an area projection type electronic gun;
the electronic gun comprises a cathode assembly and an electrode assembly;
the cathode assembly comprises a cathode, and the cathode emits electrons and forms a cathode emitting surface;
the electrode assembly comprises a plurality of metal barrels, and the plurality of metal barrels comprise a cathode modulation region metal barrel, an electron beam modulation region metal barrel and an electron beam acceleration region metal barrel; the cathode modulation region metal barrel is configured to adjust a magnitude of an electron beam current, the electron beam modulation region metal barrel is configured to adjust and control an electron beam morphology, and the electron beam acceleration region metal barrel is configured to accelerate electron beams;
an internal diameter of the electron beam modulation region metal barrel is greater than an internal diameter of the cathode modulation region metal barrel;
an internal diameter of the electron beam acceleration region metal barrel is smaller than the internal diameter of the electron beam modulation region metal barrel;
an electric potential of the electron beam modulation region metal barrel is greater than an electric potential of the cathode modulation region metal barrel;
an electric potential of the electron beam acceleration region metal barrel is greater than an electric potential of the electron beam modulation region metal barrel;
and electrons emitted by the cathode pass through the plurality of metal barrels and are then emitted in a manner of area projection, and a projection surface of the area projection is a one-time inverted real image of the cathode emitting surface.

38. The ultraviolet cathode ray tube according to claim 37, wherein the electron beam modulation region metal barrel comprises two or more sub-beam modulation region metal barrels, and each sub-beam modulation region metal barrel is connected with an independent input voltage;
and in two adjacent sub-beam modulation region metal barrels, an electric potential of the sub-beam modulation region metal barrel away from the cathode is greater than or equal to an electric potential of the sub-beam modulation region metal barrel close to the cathode.

39. The ultraviolet cathode ray tube according to claim 38, wherein in two adjacent sub-beam modulation region metal barrels, a length of the sub-beam modulation region metal barrel away from the cathode is greater than a length of the sub-beam modulation region metal barrel close to the cathode.

40. The ultraviolet cathode ray tube according to claim 38, wherein a distance between the electron beam acceleration region metal barrel and the sub-beam modulation region metal barrel adjacent to an electron beam acceleration region is greater than a distance between two adjacent sub-beam modulation region metal barrels.

41. The ultraviolet cathode ray tube according to claim 40, wherein a distance between the electron beam acceleration region metal barrel and the sub-beam modulation region metal barrel adjacent to the electron beam acceleration region ranges from 1 mm to 3 mm; and a distance between adjacent sub-beam modulation regions ranges from 0.3 mm to 1 mm.

42. The ultraviolet cathode ray tube according to claim 38, wherein internal diameters of the sub-beam modulation region metal barrels are the same and range from 8 mm to 12 mm.

43. The ultraviolet cathode ray tube according to claim 37, wherein the cathode is flush with or protrudes out of an end of the cathode modulation region metal barrel.

44. The ultraviolet cathode ray tube according to claim 43, wherein a distance for which the cathode protrudes out of the end of the cathode modulation region metal barrel ranges from 0.01 mm to 0.03 mm.

45. The ultraviolet cathode ray tube according to claim 37, wherein an electric potential of the cathode modulation region is greater than an electric potential of the cathode.

46. The ultraviolet cathode ray tube according to claim 37, wherein an electric potential of the electron beam modulation region metal barrel ranges from 0 V to 50 V; and an electric potential of the electron beam acceleration region metal barrel ranges from 5 kV to 20 kV.

47. An ultraviolet cathode ray tube, comprising:
a glass shell, a light-emitting structure layer and an electronic gun;
wherein the glass shell comprises a tubular part configured to contain the electronic gun and a fluorescent screen part connected with the tubular part;
the electronic gun is arranged inside the tubular part and configured to emit electron beams to the fluorescent screen part;
the light-emitting structure layer is arranged on the fluorescent screen part and emits ultraviolet light under exciting of the electron beams;
the light-emitting structure layer comprises a first structure layer and a conductive layer, the first structure layer is arranged on the fluorescent screen part, and the conductive layer is arranged on the first structure layer;
the first structure layer comprises a fluorescent powder layer and a filling oxide; the fluorescent powder layer comprises fluorescent powder and a bonding oxide, and the bonding oxide is configured to bond between the fluorescent powder and a surface of the fluorescent screen part;
the filling oxide is an inorganic material;
at least part of the filling oxide is filled in internal pores of the fluorescent powder layer;
the glass shell further comprises a sealing part connected with an end of the tubular part away from the fluorescent screen part, and the sealing part is configured to implement sealing an end opening of the tubular part away from the fluorescent screen part;
materials of the fluorescent screen part, the tubular part and the sealing part are quartz glass or sapphire crystal;
the sealing part is formed by deforming an end of the tubular part;
and the glass shell encloses an airtight internal space by the fluorescent screen part, the tubular part and the sealing part, and an internal space of the glass shell is in a vacuum state.

48. The ultraviolet cathode ray tube according to claim 47, wherein a maximum diameter of a section of an internal pore of the first structure layer in a direction parallel to an inner surface of the fluorescent screen part is less than 1 μm.

49. The ultraviolet cathode ray tube according to claim 48, wherein a maximum diameter of a section of an internal pore of the first structure layer in a direction parallel to an inner surface of the fluorescent screen part is less than or equal to 50 nm.

50. The ultraviolet cathode ray tube according to claim 47, wherein a weight percentage of a main component of the filling oxide is greater than 99.9%;
wherein the main component of the filling oxide refers to a component with the highest proportion in the filling oxide.

51. The ultraviolet cathode ray tube according to claim 47, wherein a weight percentage of a main component of the filling oxide is greater than 99.9%;
wherein the main component of the filling oxide refers to a component with the highest proportion in the filling oxide.

52. The ultraviolet cathode ray tube according to claim 51, wherein the main component of the filling oxide is the same as a main component of the bonding oxide;
wherein the main component of the bonding oxide refers to a component with the highest proportion in the bonding oxide.

53. The ultraviolet cathode ray tube according to claim 51, wherein the main component of the filling oxide is SiO₂ or Al₂O₃.

54. The ultraviolet cathode ray tube according to claim 47, wherein a thickness of the conductive layer ranges from 50 nm to 100 nm.

55. The ultraviolet cathode ray tube according to claim 47, wherein the fluorescent powder comprises at least one of the following: RePO₄:Z₁, LaP₅O₁₄:Z₁, CaSO₄:Z₁, SrSO₄:Z₁, NaYF₄:Z₁, LiYF₄:Z₁, KYF₄:Z₁, LiLaP₄O₁₂:Z₁, Y₂(SO₄)₃:Z₁, YAlO₃:Z₁ and YF₃:Z₁;
wherein Re represents one or more types selected from Y, La, Lu, Sr, Gd, Sm and Ce, and Z₁ represents a doping element containing one type of element selected from Nd, Pr and Bi.

56. The ultraviolet cathode ray tube according to claim 47, wherein the fluorescent powder comprises at least one of the following: RePO₄:Z₂, LaP₅O₁₄:Z₂, CaSO₄:Z₂, SrSO₄:Z₂, NaYF₄:Z₂, LiYF₄:Z₂, KYF₄:Z₂, LiLaP₄O₁₂:Z₂, Y₂(SO₄)₃:Z₂, YAlO₃:Z₂ and YF₃:Z₂;
wherein Re represents one or more types selected from Y, La, Lu, Sr, Gd, Sm and Ce, and Z₂ represents a doping element containing two types of elements selected from Nd, Pr and Bi.
